(19) United States
(12) Patent Application Publication
(10) Pub. No.: US 2014/0123161 A1
(43) Pub. Date: May 1, 2014

(54) VIDEO PRESENTATION INTERFACE WITH ENHANCED NAVIGATION FEATURES

(71) Applicants: Bart P.E. van Coppenolle, Leuven (BE); Philip W.J. Vandormael, Leuven (BE)

(72) Inventors: Bart P.E. van Coppenolle, Leuven (BE); Philip W.J. Vandormael, Leuven (BE)

(21) Appl. No.: 14/062,479

(22) Filed: Oct. 24, 2013

Related U.S. Application Data
(63) Continuation-in-part of application No. 13/947,276, filed on Jul. 22, 2013.
(60) Provisional application No. 61/717,833, filed on Oct. 24, 2012.
(60) Provisional application No. 61/812,924, filed on Apr. 17, 2013.

(51) Int. Cl. H04N 21/81; H04N 21/2543; H04N 21/435

(52) U.S. Cl. CPC H04N 21/812; H04N 21/435; H04N 21/2543
USPC 725/8; 725/34

(57) ABSTRACT

A system and technique for simultaneously presenting multiple, content object data streams on a user interface in a manner which encourages multidimensional browsing using directional navigation commands from a traditional remote control allows a viewer to select from live broadcast content, previously recorded content, and content which has yet to be recorded. According to another aspect of the disclosure, a viewer may view in a time shifted manner, not only previously recorded content, but any advertisements or commercials contained in, including possibly skipping an advertisement, if the profile associated with the viewer has earned enough viewing credit to perform such activity.

### RELATED APPLICATIONS

This application claims priority to the following co-pending U.S. patent applications, the subject matters of which are incorporated herein by this reference for all purposes, including the following:

U.S. patent application Ser. No. 13/947,276, filed on Jul. 22, 2013, entitled “Method And Apparatus For Content Presentation In A Tandem User Interface”, attorney docket number 43854-00123 CON of which this application is also a continuation-in-part thereof;

U.S. Provisional Patent Application Ser. No. 61/717,833, filed on Oct. 24, 2012, entitled Video Presentation interface With Enhanced Navigation Features“; and

U.S. Provisional Patent Application Ser. No. 61/812,924, filed on Apr. 17, 2013, entitled Video Presentation interface With Enhanced Navigation Features”.

### FIELD OF THE INVENTION

The disclosure relates to viewing of content, and, more specifically, to systems and techniques for presenting a user interface for viewing video content which provides enhanced navigation features.

### BACKGROUND OF THE INVENTION

Relaxation is the main reason why people watch television. Current television interfaces however frustrate people instead of relaxing them, because they require such operations like scrolling through text-based menus or EPGs (electronic program guides) and programming the recording of content.

Accordingly, a need exists for a system that provides the advantages of digital television, video and Web TV such as browsing through web content, Video-On-Demand, time shifting etc, and that simultaneously supports the relaxing nature of the television viewing experience.

Some current web TV systems allow the user to create virtual channels. However, these systems require the user to go through menus and type in key words using a keyboard-like device, while sitting in front of their television. This does not support the relaxing nature of the natural TV viewing experience. On the contrary, it often jeopardizes relaxation and sometimes even causes frustration.

Accordingly, a need exists for a system that supports relaxation while using virtual channels, by separating the management of virtual channels from the relaxed experiencing of those virtual channels.

Individual users of interfaces for broadcasted media or TV are limited to the specific time slots in which the broadcaster chooses to make a particular program available. This specific time does not necessarily match the mood and availability of the viewer. If the viewer is not available or in the mood at the time of airing of such content, the program must either be recorded or missed with the hopes that it will be re-aired later.

Recording devices which enable time shifted viewing have physical restrictions associated with the system, such as the number programs which may be recorded, or, the number programs which may be simultaneously record, but the most important disadvantage is the hassle and frustration accompanying the programming of recording and the selection and replaying of recorded content.

Although Catch-Up TV is available for time shifting, its functionality is limited and its use does not support the relaxing nature of the natural TV viewing experience. Both selection of time shifted content and programming of time shifting devices are not relaxing, involving too much left brain activity.

Accordingly, a need exists for a system and technique in which program content may be accessed and viewed in a time-shifted manner to suit the viewers' availability, convenience, and mood. A need exists for a system and technique in which program content may be accessed and viewed in a time-shifted manner, which overcomes the current limitations of existing technologies.

Media or television advertisement often interrupts the relaxing nature of watching the content, creating annoyance and frustration. When watching recorded content, one can fast-forward advertising manually, an option unavailable for broadcasted content on air. The problem with advertisement skipping in recorded time shifted content is that it potentially may jeopardize the business model of broadcasters or content creators that use advertisement as a source of income to finance the broadcasting service or content creation. Also, current systems do not verify whether a viewer actually watched an advertisement, so they cannot guarantee the advertiser value is actually created. Also current systems do not allow for the user to pull advertising of interest, such pulled advertisement of interest is of higher value to advertisers, than the mass bulk advertisement or personalized pushed advertisement.

Systems, which have tried to improve relaxation by altering the advertising viewing behavior, did not respect the advertising business of the television broadcasters.

Accordingly, a need exists for a system that addresses viewing of advertising in a more flexible and relaxing way, without jeopardizing the advertising business of broadcasters. A need exists for a system that allows television viewers to delay or time shift advertising to support the relaxing nature of the natural viewing experience and at the same time does not jeopardize advertising income.

### SUMMARY OF THE INVENTION

According to another aspect of the disclosure, a system and technique uses advertisement accounts for some or all of its TV user accounts and broadcasters. For TV viewers, advertisement should not disturb the natural relaxing nature of the TV viewing experience. Therefore being able to watch advertisements of interest when TV viewers want it is a design imperative for the relaxing TV experience.

Such relaxed TV viewing experience can be achieved by simply skipping the viewing of TV commercials or other advertisement. Since advertisers pay for the free or reduced cost viewing of consumers, this solution does not satisfy interests of the supply side of the market. However a solution can be devised that reduces the frustration of the TV viewer, while at the same time protecting the value created for advertisers and broadcasters, since not frustrating the viewer is the value creation mechanism for the advertiser, on the contrary.

For advertisers and broadcasters, a TV commercial or other advertisement is more valuable if it is more personalized to the interest of the viewer, when the viewer watches it at his/her own convenience, in a relaxed mood, when the viewer pulls the advertisement rather than that the advertisement is pushed to the viewer and of course if the TV user actually watches the advertisement, instead of simply taking a break.

A credit model takes these value creation parameters into account, by crediting the advertisement account. For each viewer or viewer profile or each family or home or other group validly subscribed, combined with each broadcaster or group of cooperating broadcasters a separate advertisement account is kept. Each advertisement account is credited using the advertiser value credits model, potentially but not necessary including a monetary payment system to credit the advertisement account. Such same advertisement account is then debited using a broadcaster cost or selling price debit model.

According to one aspect of the disclosure, a method for selectively navigating advertisement content in a prerecorded video stream comprises: A) maintaining, in a computer memory, a viewer profile having associated therewith an account balance representing value to the viewer; B) receiving, from the viewer, a command instruction to perform a navigation activity other than viewing an advertisement content section in a video stream of a content object; C) determining if the account balance associated with the viewer profile is within an acceptable range of a predetermined threshold value; and D) enabling execution of the command instruction to perform the navigation activity if the account balance is within an acceptable range of the predetermined threshold value, else preventing execution of the command instruction.

According to another aspect of the disclosure, a system for selectively navigating advertisement content in a content object comprises: a video display; a video playback engine responsive to viewer navigation commands for streaming video to the video display; a memory for storing a viewer profile having associated therewith an account balance representing value to a viewer; a processor operatively coupled with the memory and video playback engine and configured to: i) maintain, in the memory, the viewer profile having and the associated account balance, ii) receive, from the viewer, a command instruction to perform a navigation activity other than viewing an advertisement content section in a video stream of a content object, iii) determine if the account balance associated with the viewer profile is within an acceptable range of a predetermined threshold value, and iv) enable execution of the command instruction to perform the navigation activity if the account balance is within an acceptable range of the predetermined threshold value, else preventing execution of the command instruction.

According to another aspect of the disclosure, a system for viewing personalized advertisement content in a video stream comprises: a video display; a video playback engine responsive to viewer navigation commands for streaming video to video display; a memory for storing a viewer profile having associated therewith an account balance representing value to the viewer and a plurality of advertisement content recommended in accordance with the viewer profile; a processor operatively coupled with the memory and video playback engine configured to: i) stream with the video playback engine to the video display a prerecorded video content object containing video content and one or more advertisement sections, ii) receive, from the viewer, a command instruction to view an advertisement content section other than an advertisement section in the video stream of a content object, and iii) stream with the video playback engine to the video display at least one of the plurality of advertisement content recommended in accordance with the viewer profile.

According to still another aspect of the disclosure, a method for viewing personalized advertisement content in a video stream comprising: A) maintaining, in a computer memory, a viewer profile having associated therewith an account balance representing value to a viewer and references to a plurality of advertisement content sections recommended in accordance with the viewer profile; B) presenting a video stream of a video content object comprising video content and one or more advertisement content sections, C) receiving, from the viewer, a command instruction to view an advertisement content section other than one of the advertisement content sections in the content object, and D) presenting, in place of the advertisement content section in the content object, at least one of the plurality of advertisement content sections recommended in accordance with the viewer profile.

Also disclosed herein is a video display system having navigation controls, such as a standard television remote control with directional cursor navigation controls (e.g. up, down, left, and right). An application executing in conjunction with the video display interface intercepts and redefines the cursor navigation control commands from the remote to enable them to be utilized as the primary mechanism for surfing/selecting channel(s) and initiating viewing of content objects associated with the viewer's neuropsychological behavioral profile, as described herein. In one embodiment, the up and down cursor controls of a remote may be utilized to move through content objects, previously ranked within a channel, according to increasing or decreasing emotional motivation of the subject to select such content objects relative to a subject's behavioral data. In another embodiment, the left and right cursor arrows of the remote may be utilized to select chronologically backward or forward other control objects, respectively, relative to a currently selected content object, for example, for past or future episodes of the same program series currently being viewed or recently viewed.

According to still another aspect of the disclosure, a video display system comprises: a video display; a plurality of directional navigation controls for sequentially moving a user selectable sub-area of the video display in one or more directions about the video display area; and control logic for receiving command signals associated with one of the navigation controls and for redirecting the command signal to initiate presentation of a first content object from among a first plurality of content objects; wherein the first plurality of content objects comprises content objects representing any of previously recorded video content, live broadcast video content, and video content viewable in the future.

According to still another aspect of the disclosure, a video display system comprises: a video display; control logic for generating a video display interface having a main viewing area and a navigation bar configured for displaying a plurality of chapter units associated with a content object being displayed in the main viewing area; and a plurality of directional navigation controls for providing directional commands to the video display interface and navigation bar; wherein each of the plurality of chapter units has associated therewith a thumbnail image representing a position within the respective chapter unit of the content object; and wherein the plurality of directional navigation commands may be utilized to navigate among the chapter units of the content object by selecting a corresponding thumbnail displayed in association with the navigation bar.

### DESCRIPTION THE DRAWINGS

FIG. 1A illustrates conceptually an interface system for a viewer in accordance with the disclosure;

FIG. 1B illustrates conceptually the algorithmic process performed by redirection application.

FIG. 1C illustrates conceptually the algorithmic process performed by the modeling system in accordance with the disclosure;

FIGS. 1D and 1E in combination illustrate conceptually another algorithmic process performed by the viewer system for navigation and display of content objects in accordance with the disclosure;

FIG. 2A illustrates conceptually a channel which enables multidimensional surfing of content using traditional cursor navigation controls in accordance with the disclosure;

FIG. 2B illustrates conceptually the implementation of a channel associated with a specific subject/viewer in accordance with the disclosure;

FIG. 2C illustrates conceptually a sample data structure from which the groups within channels may be constructed in accordance with the disclosure;

FIG. 2D also Illustrates conceptually a data structure of a channel model which enables multidimensional surfing of content using traditional cursor navigation controls in accordance with the disclosure;

FIGS. 3A-B illustrates conceptually a network environment in the disclosed systems and techniques may be implemented in accordance with the disclosure;

FIG. 4 illustrates conceptually an interface system for a viewer in accordance with the disclosure;

FIG. 5 illustrates conceptually a data structure utilized in accordance with the disclosure;

FIG. 6 illustrates conceptually the relationship of components within display 80 including buffering of multiple content object data streams;

FIG. 7 illustrates conceptually a sample data structure which may be used with each displayed content object data stream;

FIG. 8 illustrates conceptually a user interface for presenting multiple content object data streams to a viewer;

FIG. 9 illustrates conceptually a user Interface for presenting multiple content object data streams to a viewer,

FIG. 10 illustrates conceptually various graphic indicia associated with multiple content object data streams;

FIG. 11 illustrates conceptually a user interface for presenting multiple content object data streams that have recommended to a viewer;

FIG. 12 illustrates conceptually a user interface for presenting multiple content object data streams that allow for surfing of nested dimensions;

FIG. 13 illustrates conceptually a remote control device useful with the Interface system in accordance with the disclosure;

FIGS. 14-15 illustrate conceptually horizontal and vertical configurations of a navigation bar, respectively, of a user interface in accordance with the disclosure;

FIGS. 16-17 illustrate conceptually configurations of a calendar navigation bar of a user interface in accordance with the disclosure;

FIGS. 18-19 illustrate conceptually states schema for navigation bars of a user interface in accordance with the disclosure;

FIG. 20 illustrates conceptually a chapter navigation bar of a user interface in accordance with the disclosure;

FIG. 21 illustrates conceptually a sample data structure which may be used to track advertisement time shifting credits in accordance with the disclosure;

FIG. 22 illustrates conceptually an algorithmic process for tracking and enabling advertisement time shifting behavior in accordance with the disclosure; and

FIG. 23 illustrates conceptually a sample data structure which may be used to update personalized advertisement in accordance with the disclosure.

### DETAILED DESCRIPTION

### User Interface for Presentation and Surfing of Multiple Content Objects

According to one aspect of the disclosure, a system and technique for presenting multiple, simultaneous content object data streams on a user interface is provided in a manner that facilitates surfing by the viewer in multiple dimensions. One such system is disclosed in U.S. Pat. No. 8,495,683, issued Jul. 23, 2013, entitled Method And Apparatus For Content Presentation In A Tandem User Interface”, the subject matter of which is Incorporated herein by this reference for all purposes. A primary content stream, representing the currently selected content object within a dimension of a viewer channel, is presented in a substantial portion of the right brain user interface display area while a plurality of secondary content object data streams, representing selectable content objects to which the viewer may navigate, are presented in smaller sized or thumbnail format in the balance of the display area of user interface. The multiple secondary content streams presented on the user interface each represent selectable content objects having a queued relationship to the currently selected primary content object data stream. Such a queued relationship may exist between and among different content object streams in the same dimension of a viewer channel or between separately selectable portions of a single content object stream or program, or between different content objects in this dimensions of a viewer channel, e.g. chronologically arranged episodes of the same program.

### Viewer System

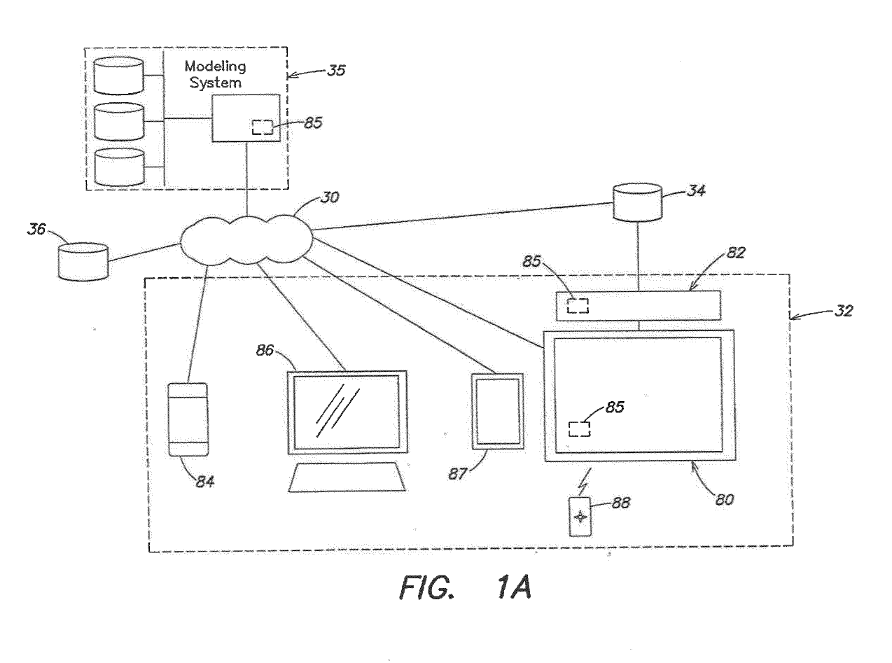

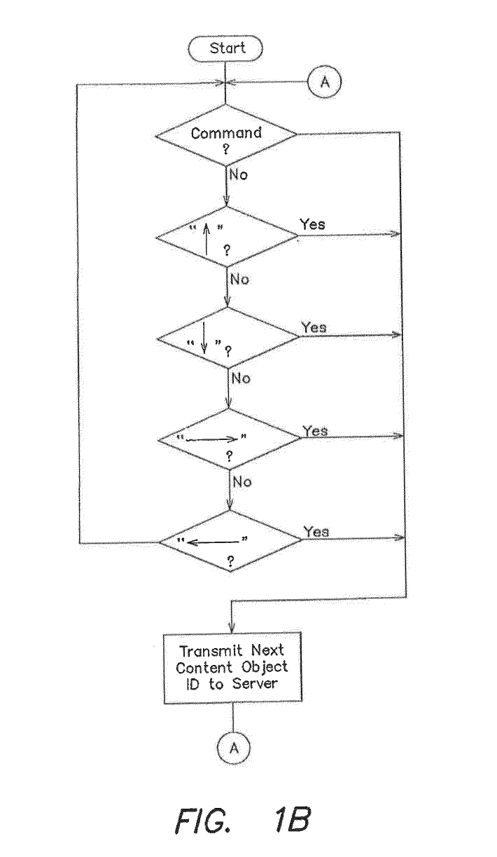

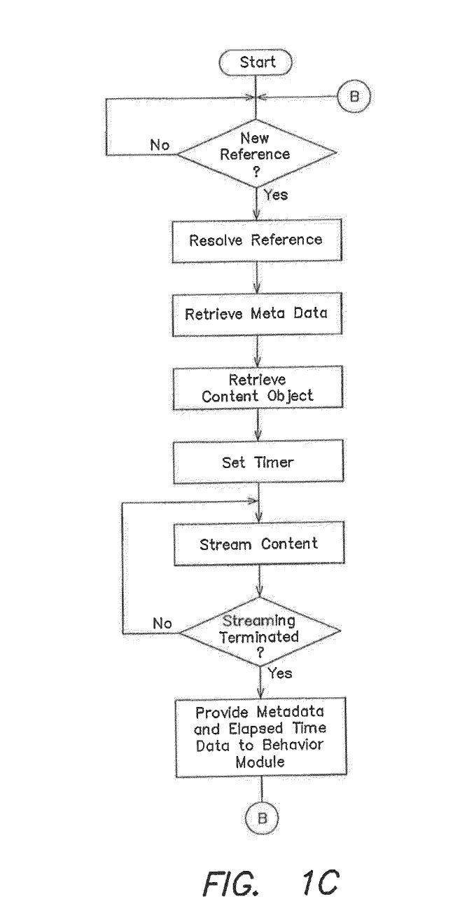

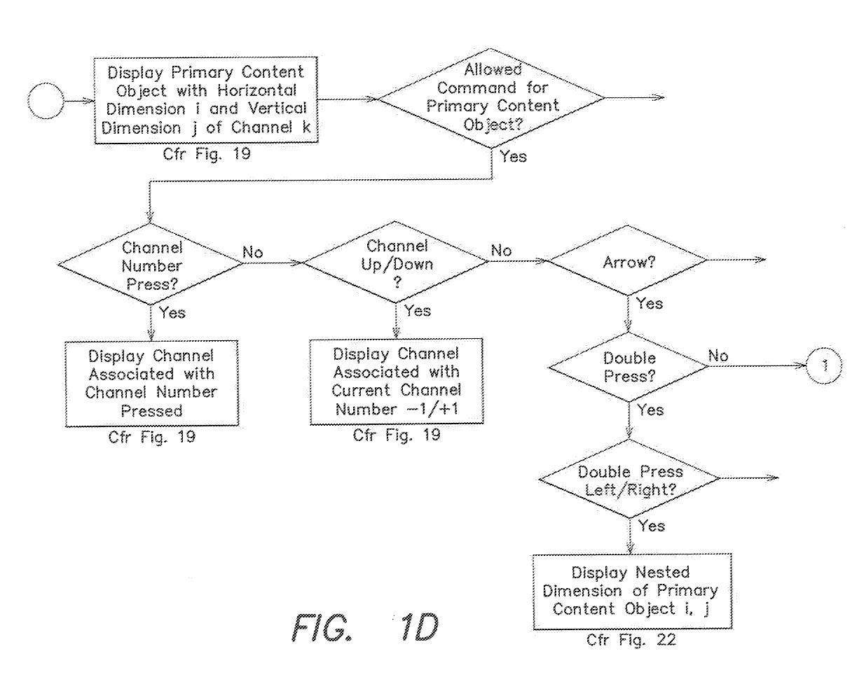

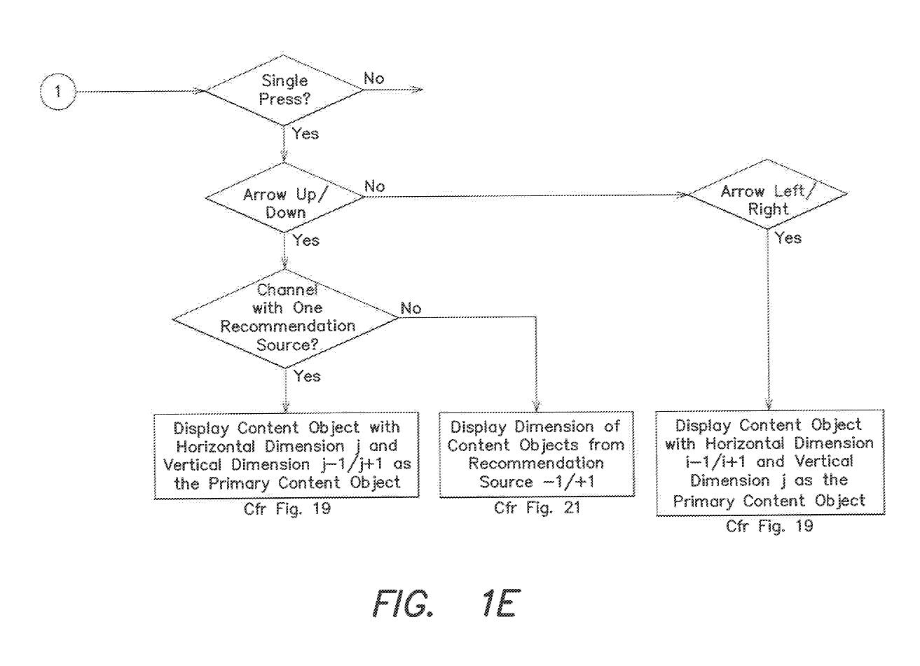

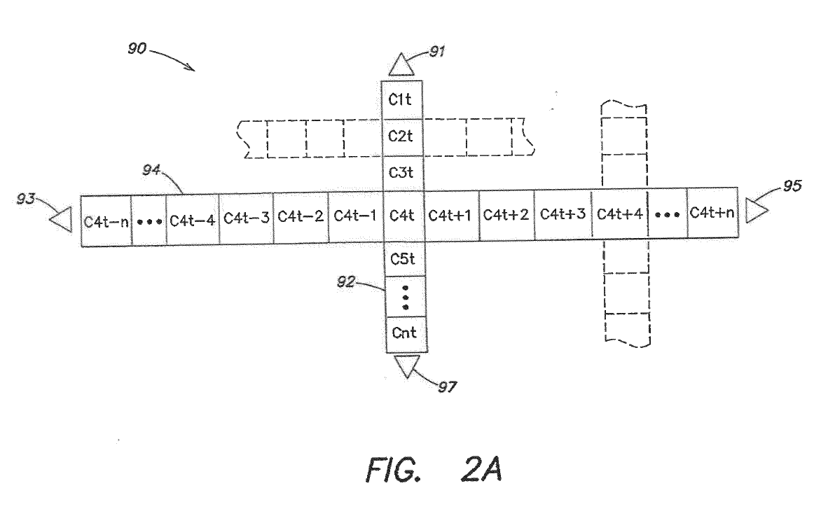

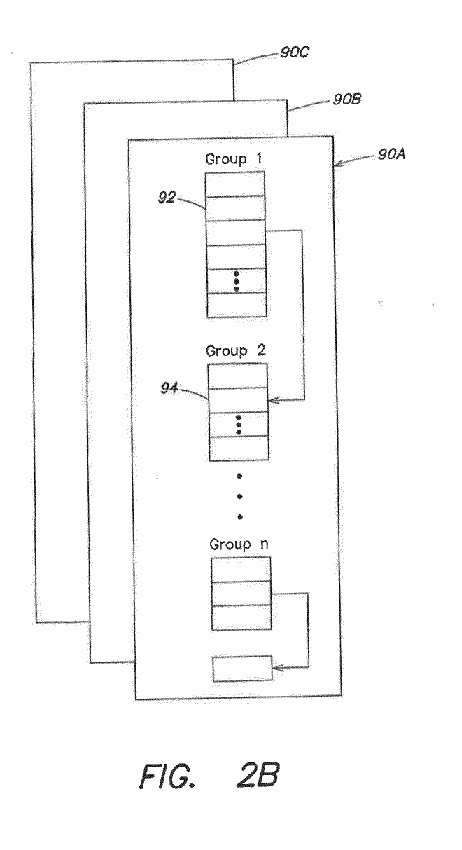

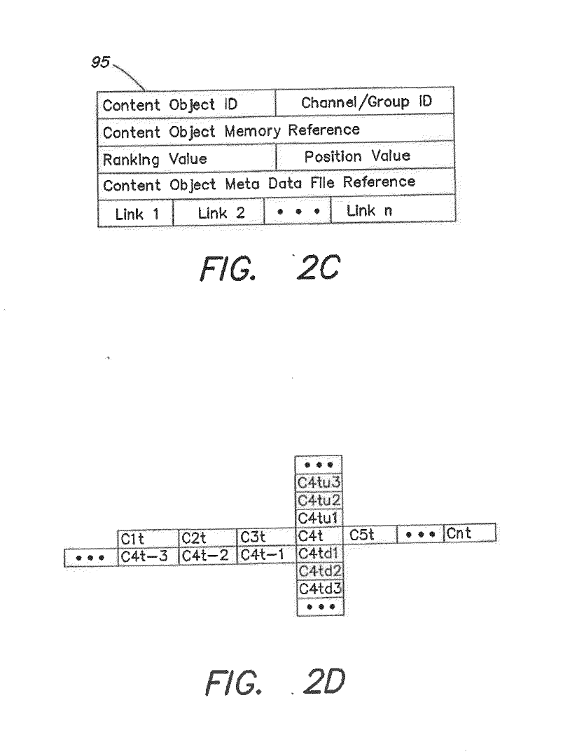

FIG. 1A illustrates conceptually a viewer interface system 32 relative to public network 30, content provider sources 34 and 36 and modeling system 35 in accordance with the disclosure. Also Illustrated in FIG. 1A is the remote control 88 associated with display 80. The viewer system 32 comprises a first or right brain user interface display 80, used predominantly for viewing of video content which, in the illustrative embodiment, may be implemented with television display 80 and an accompanying remote control 88. Display 80 may be implemented with a “connected TV” or other devices that connect the TV to the networks 30 or 31 such as a connected Blu-ray player or a connected game console, e.g. a device capable of connecting directly to the Internet, e.g. network 30, as well as a cable packet network or satellite network, e.g. network 31. Viewer system 32 further comprises a second or left brain user interface 84 which presents a content surfing interface and purchasing interface and may be implemented on a Personal Digital Assistant (PDA) or smart phone, tablet computer or even laptop computer. Such second user interface predominantly uses and/or stimulates activity in the left hemisphere of the human brain, and also, to a limited extent, the right hemisphere of the human brain. A viewer will typically utilize the second user interface 84 to perform activities such as storing, purchasing, changing the order of, specifying a like/dislike for a particular content object within the rankings of a channel 90. Viewer system 32 further comprises optional, third and fourth user interface 86 and 87, respectively, capable of presenting both the textual based interfaces for content surfing and purchasing, as well as visual content and may be implemented with a traditional personal computer, including a desktop or laptop system, as well as other systems. In an exemplary embodiment, display 80 presents visual, non-textual information while one, two or all three of phone/PDA 84, personal computer 86, and/or tablet computer 87 display textual information, such as a representation of the content contained with channels 90A-C of FIG. 2B, or other textual based data. Note also that personal computer 86 and tablet 87 may also be used to display visual information. The predominance of brain activity for the various user interfaces in viewer system 32 is indicated in the table below:
Display 80: full Right, minimal Left
Tablet 87: mainly Left, limited Left, full Right optionally
Smartphone/PDA 84: mainly Left/limited Left, limited Right optionally
Personal Computer 86: full Left, limited Right optionally

In the disclosed embodiments, the elements of viewer system 32 may be implemented with existing commercially available technology. For example, display 84 may be implemented with any number of smartphones or personal digital assistant devices including, but not limited to the Apple iPhone and Android operating system based smartphones commercially available from any number of manufacturers including Samsung, HTC, Alcatel, Acer. Sony Ericsson, HTC, LG, Google Nexus, ZTE, Motorola, etc. This display 87 may be implemented with the tablet computer including, but not limited to the Apple iPad and Android operating system based tablets, commercially available from any number of manufacturers including Acer, Archos, Dell, Motorola, Samsung, Sony, Toshiba, ZTE, etc. . . . As described previously, display 80 may be implemented with a connected TV, as well as a traditional television display devices which rely on supplemental equipment, such as set top box 82, for connection to a source of content, including, but not limited to those commercially available from any number of manufacturers including LG, JVC, Panasonic, Philips, Samsung, Sharp, Sony, etc.

Display 86 may be implemented with any number of computer systems including, but not limited to the Apple iMac and IBM PC compatible personal computers, commercially available from any number of manufacturers including Acer, Hewlett-Packard, Asus, Samsung, Sony, Dell, Toshiba, etc. Set top box 82 may be implemented with any number of commercially available set-top box devices or gaming platforms of either an open architecture or proprietary architecture, depending on the source of the content accessed thereby, including those commercially available from any number of manufacturers including Sony Playstation, Apple Mac Mini, Nintendo Wii, Microsoft Xbox, etc. Remote 88 may be implemented with any number of standard design remote controls from TV manufacturers, or, alternatively, may be implemented with an if market remote such as those manufactured by Logitech, Inc.

According to the disclosure, the traditional cursor navigation controls of remote 88 are utilized as the primary mechanism for surfing the channel(s) of previously aggregated and ranked content associated with the viewer's neuropsychological profile, as described previously. The traditional functions of the cursor navigation control commands generated by remote control 88 may be overridden and/or redirected utilizing a redirection application 85 selectable with the remote or directly from the front panel of display 80. Such programs may execute either directly on the processor and operating system of display 80 in case of a connected TV or other connected devices, or, alternatively, on the set top box 82 associated with display 80, or remotely on server 40 of modeling system 35 remotely connected to viewing system 32 through public network 30.

In an exemplary embodiment, each of the cursor navigation controls are redirected to initiate retrieval and review of a content object which has been previously ranked within a channeling, as described herein. FIG. 1B illustrates the algorithmic processes performed by redirection application 85. First, upon activation, application 85 waits for commands signals sent remotely from remote control 88. As will be understood by those reasonably skilled in the arts, such signals may be transmitted through either tangible electrical conductors or wirelessly through any number of technologies, including optical, microwave, etc. Application 85 examines the data of a received signal, typically the field within a header file or data stream which identifies a command, to determine if the received signal associated with a received command identifies one of the signals to be redirected, such as the Up, Down, Left and Right cursor navigation signals of remote 88. If so, depending on which cursor navigation command is received, the redirection application 85 transmits to modeling system 35 the data necessary to identify the new content object to be viewed. Such data may be implemented in any number of different techniques, such as with a memory off-set to a currently or recently viewed content object, with a sequence number identifying the next content object within the channel data structure 95, or with a resolvable link retrieved from the metadata file contents associated with the currently displayed object, as stored locally within viewer system 32 or remotely within modeling system 35.

FIG. 1C illustrates the algorithmic processes performed by server application 51 of modeling system 35 upon receipt of handle or reference data from redirection application 85 identifying the next content object to be displayed. Depending on the nature of the handle or reference data, server application 51 resolves any addresses, links or references to the next content object to be displayed and then retrieves the metadata file associated with such content object, typically from database 47. Thereafter, the actual data associated with content object is retrieved from database 47 and streamed to first user Interface 80 of viewer system 35 via either public network 30 or private network 31, depending on the exact implementation of the system. Simultaneously with the initiation of content streamed to viewer system 32, server application 49 may start a timer to determine the last time until streaming is terminated, typically when the next content object to be viewed is selected. Upon receipt of a command to terminate streaming, server application 51 transmits a value representing the elapsed time of the previously reviewed content object along with the metadata of the content object to behavioral model module 49 for updating of the viewer's behavioral model. Other available commands may similarly cause content streaming to terminate and the viewer's behavioral model to be updated with the elapsed time, including, but not limited to, channel up/down, back button (results in starting another content object), pause, fast-forward, rewind (within the content object), etc. Alternatively, rather than maintaining an elapsed time value, server application 51 may examine the time code embedded within the header of the last streamed data packet to determine approximately how much of the content object was viewed by the viewer before streaming was terminated. Data representing the elapsed time based on this value can then similarly be sent to behavioral model module 49. Thereafter, a similar process occurs for identifying, retrieving and streaming the next content object to be viewed.

Both Implicit and explicit data/events can cause “arrow A” function. Implicit data/events may include:
Basic viewing operation events (either from right brain user interface on display 84, 86, 87 or using remote control 88):
   Play (request a specific program, continue viewing of content object)
   Pause
   Fast forward/rewind
   Stop (completion of viewing)
   Surf to other content object within channel
   Surfing to other channel
Purchasing of content
Sequence of events within a certain time frame (e.g. surfing multiple times back and forth to a certain content object)
Operation around a certain time frame “within” the content object e.g. surfing away when a commercial starts, a bloody scene, . . . .
   Explicit data/events may include:
Provide feedback using the colored buttons on the remote control 88 (or equivalent right brain user interface element of display 84, 86, 87)
Manage channel using left brain user interface on display 84, 86, 87
Enter search term using left brain user interface on display 84, 86, 87
   Additional commands that may result in transmission of a new content object includeDouble arrow left, Double arrow right, Back button, and “OK” button (if it is an item that should be purchased only a trailer is retrieved when accessing this item using the arrows; OK triggers the transmission of paid content).

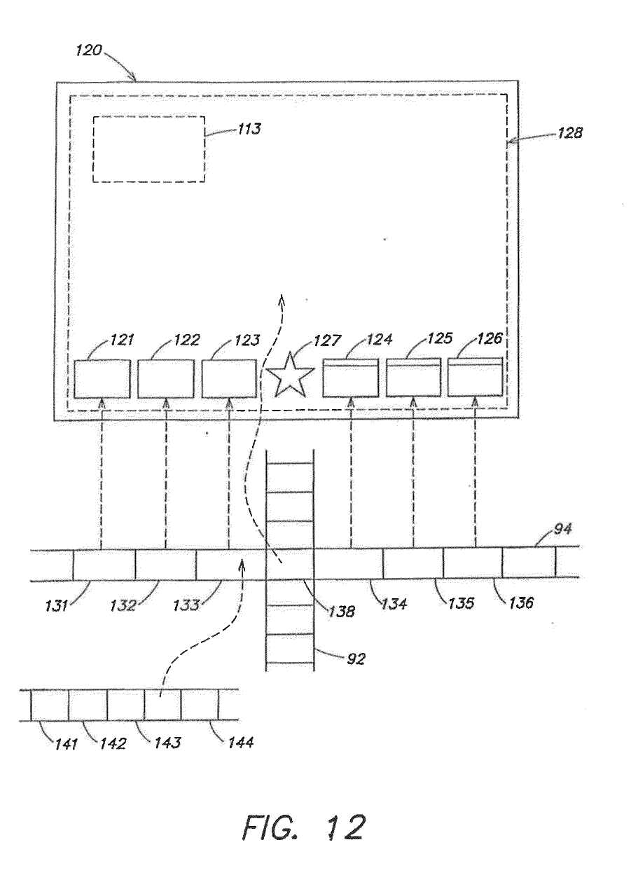

The process of utilizing the cursor navigation controls to perform multi-dimensional surfing of content objects within a particular viewer channel is described herein with reference to FIGS. 2A-B. FIG. 2A illustrates conceptually a multidimensional channel 90, which facilitates multidimensional surfing of content along desire and time vectors 92 and 94, respectively, using traditional cursor navigation controls. FIG. 12B illustrates conceptually the implementation of channel 90 associated with a specific subject/viewer within database 48. Channel 90 may comprise a plurality of channels 90A-C, stored in database 48 of modeling system 35.

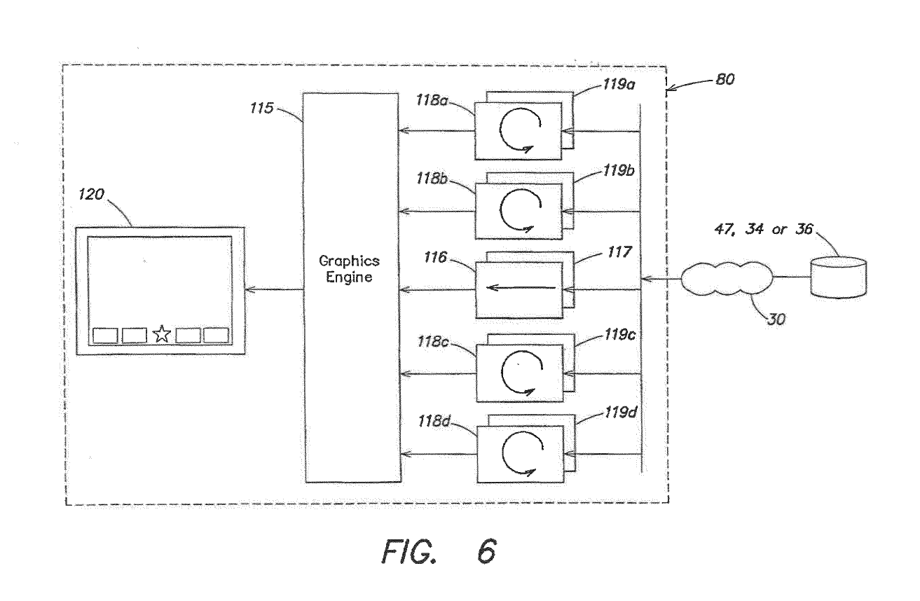

The process by which navigation controls may be utilized to perform multi-dimensional surfing and viewing of content object streams displayed on viewer system 32 within a particular viewer channel 90 is described with reference to FIGS. 6-2 referring to FIG. 6, database 48 of modeling system 35 interacts with content database 47 or other content sources 34, 36 to ensure that a data stream representing the content object(s) within viewer channel 90 are buffered in memory associated with viewer system 32 for rendering and display on display 80.

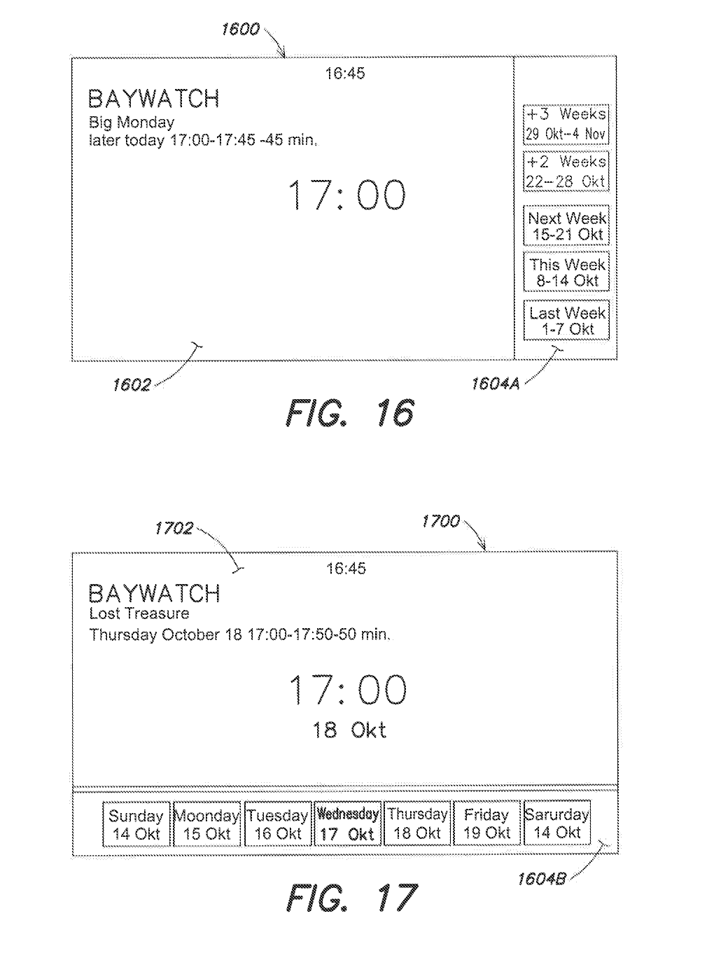

Viewer interface system 32 comprises the right brain user interface display 80, used predominantly for viewing of video content and an accompanying remote control 88. As noted previously, display 80 may be implemented with a “connected TV” or other devices that connect the TV to the networks 30 or 31 such as a connected Blu-ray player or a connected game console, e.g. a device capable of connecting directly to the Internet, e.g. network 30, as well as a cable packet network or satellite network, e.g. network 31. FIG. 6 illustrates conceptually the relationship between the components of display 80 (in phantom), including User Interface (UI) display area 120, graphics engine 115, a primary stream buffer 116 and multiple secondary stream buffers 118a-n associated with the content objects comprising a viewer channel. Graphics engine 115 is typically part of display 80 and controls the streaming, decryption, windowing, and rendering of multiple data streams based on the content data and command/formatting data contained within the data packets associated with each stream. Buffers 116 and 118 may be implemented as segmented sections of local memory associated with graphics engine 115, or, alternatively, may be stored separately and remotely from display 80. Display 80 and viewer system 32 are connected through the network 30, represented as a cloud in FIG. 16, to modeling system 35 and the source of the content object data streams, typically any of database 34, 36, 37 or 47. A multitasking/multithreaded operating system may be used in viewer system 32 to control the streaming, buffering and rendering of the content object data stream. Specifically each stream may have associated therewith multiple threads of execution, including a thread for buffering and one or more threads for formatting and rendering the content object data on display area of display 80. As illustrated in FIG. 6, the primary content object stream has a buffer 116 associated therewith and one or more threads, labeled collectively as 117. The plurality of secondary content object streams each have a perspective buffer 118a-n associated therewith and respective sets of one or more threads, labeled collectively as 119a-n, as illustrated. In the disclosed embodiment, primary content object data stream 128 is continuously streamed from its original source via its respective buffer while secondary content object data streams 121-126 may optionally loop through a portion of their respective content, typically the first several minutes or another amount stored in each of the respective buffers. In this manner, the presentation of visual information to the viewer on UI display area 120 is more informative, particularly regarding secondary content object data streams 121-126, will efficiently using processor resources within graphic engine 115 and network bandwidth into and out of viewer system 32.

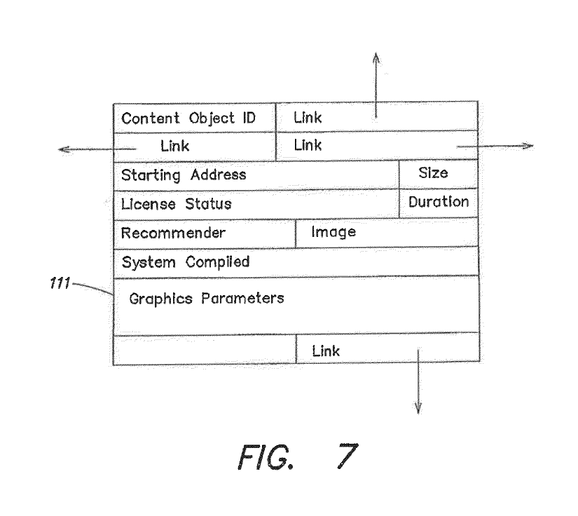

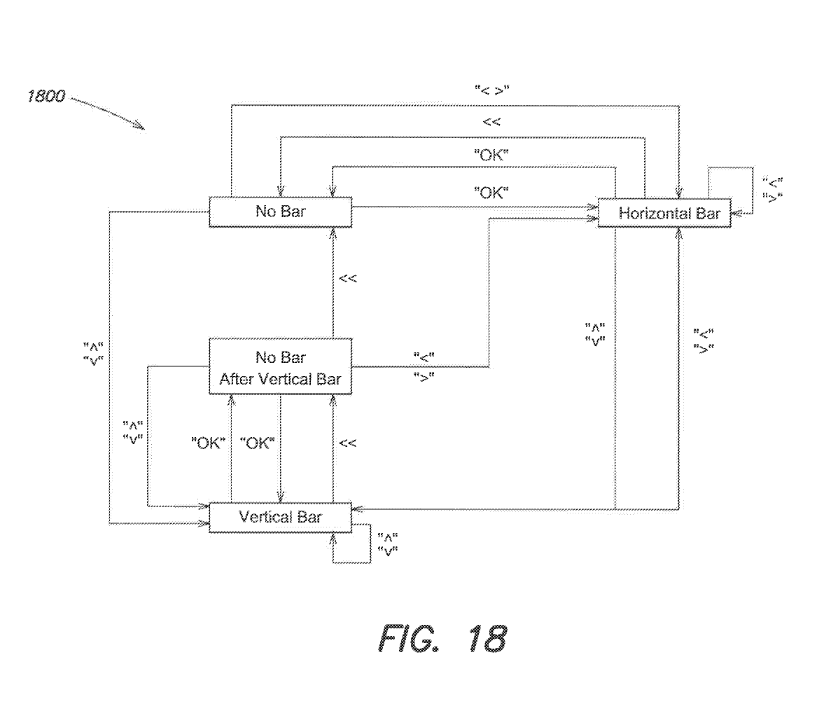

Each content object having data streamed to display 80 has associated therewith a data structure 111, as illustrated in FIG. 7, which comprises information relating to the viewable parameters of the content object, including, but not limited to formatting parameters, status, navigation options and proprietary rights data. In addition to metadata relating to the content object, such as the object identifier, format identifier, links to other content objects within the viewer channel, the memory address where the data comprising the object is stored, and the size of the content object, data structure 111 further comprises data fields indicating the license status of the object, whether free (prepaid), pay-per-view, or pay for limited use, elapsed viewing time, whether the content object was compiled by modeling system 35, the name of someone recommending the content object, an image of the person recommending the content object, and other data necessary for representation of the various graphical elements and indicia surrounding the rendering of the content object, as explained in more detail with reference to FIGS. 18-22.

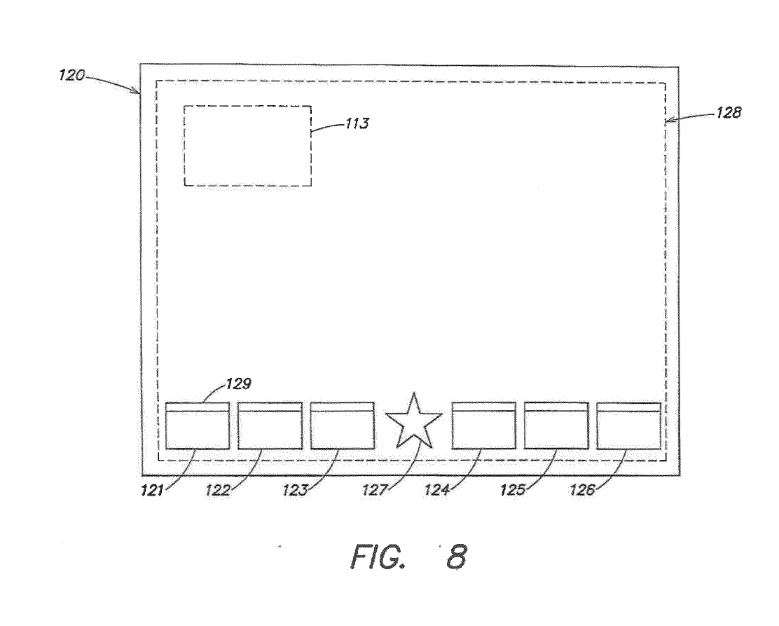

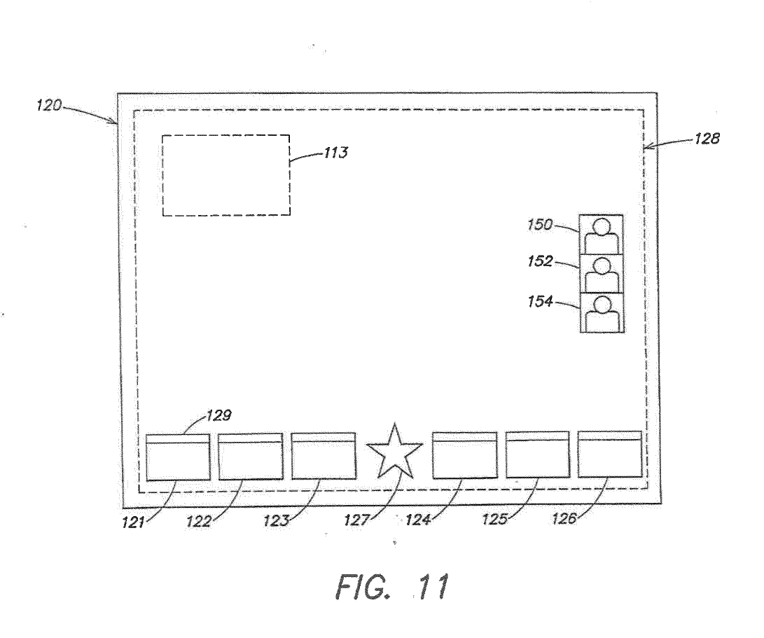

Referring to FIGS. 8 and 11, the UI display area 120 of display 80 is illustrated. Multiple content object data streams are capable of being simultaneously presented in UI display area 120. A primary content object data stream 128, illustrated in phantom, representing the currently selected content object within a dimension of viewer channel 90, is presented in the substantial majority portion of the UI display area, while a plurality of secondary content object data streams 121-126, representing selectable content objects within the viewer channel to which the viewer may navigate, are presented in smaller-sized or thumbnail format at the bottom of the UI display area 120. In this manner, the multiple secondary content object streams presented on the user interface each represent selectable content having a relationship to the currently selected primary content object stream. In FIG. 8, the plurality of secondary content object data streams 121-126, and icon 127 representing the primary content object data stream, arranged along the bottom dimension of UI display area 120, and may be associated, for illustrative purposes, with the time or second dimension is described elsewhere herein. Similarly, in FIG. 8, icon 127 and the plurality of secondary content object data streams 121-126, arranged along a side dimension of UI display area 120, and may be associated, for illustrative purposes, with the association or first dimension, as described elsewhere herein. Note that icon 127 and the secondary content object data streams 121-126 may be arranged vertically along either the left or the right side of UI display area 120. The thumbnail frames representing the content object streams of a dimension may be arranged linearly along any portion of UI display area 120 including any of the left, right, top, and bottom sides of UI display area 120. Alternatively, other arrangements of the thumbnail frames may be utilized within UI display area 120, for example circular or cluster arrangements of the thumbnail frames to provided the viewer with navigable options representative of the dimensions available for surfing relative to the currently displayed primary content object data stream 128.

Referring to FIG. 9, and as described elsewhere herein, such a queued relationship may exist between and among different content object streams or between separately selectable portions of a single content object stream or program. For example, secondary content object data streams 121-126 may represent successively ordered content objects 131-136, respectively, relative to the primary content object stream 128, which represents the currently selected content object 138 in second dimension 94 in a viewer channel 90. Alternatively, secondary content object streams 121-126 may represent successively ordered content objects representing a viewer selectable segments of the currently viewed content object in display area 120. For example, a primary content object stream representing a news program may have separately selectable secondary content object streams for program segments directed to weather, sports, business/finance, consumer reporting, etc. As another example, a primary content object stream representing the sports section of a news program may have multiple separately selectable secondary content object streams representing different video clips of sports highlights within the sports segment. In a similar manner, referring to FIG. 9, a queued relationship may exist between and among different content object streams or between separately selectable portions of a single content object stream or program. For example, secondary content object data streams 121-126 may represent successively ordered content objects 131-136, respectively, relative to the primary content object stream 128, which represents the currently selected content object 138 in first dimension 92 in a viewer channel 90. Alternatively, secondary content object streams 121-126 may represent successively ordered content objects representing a viewer selectable segments of the currently viewed content object in display area 120.

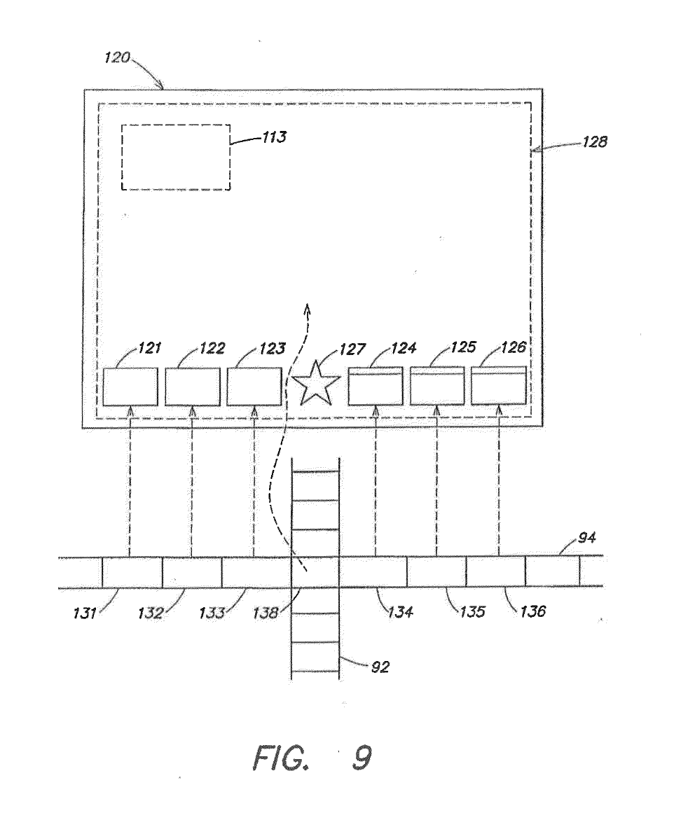

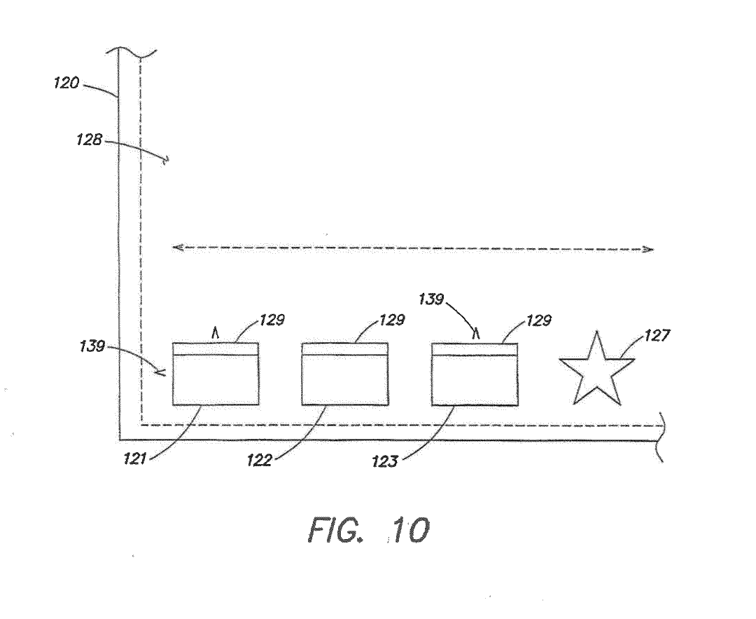

In one embodiment, secondary content object data streams 121-126 are displayed on UI display area 120 for a predetermined period of time, e.g. between 2 to 20 seconds after the last navigation command, or for some other predetermined period of time, so as not to distract the viewer from the primary content object data stream 128. Pressing of a navigation command button on the remote 88 will cause secondary content object data streams 121-126 to reappear, therefore providing the viewer with the necessary video cues to facilitate surfing among the various content objects within a dimension of a viewer channel. In another embodiment, as the viewer navigates or “surfs” among the various content objects, selection of a new primary content object data stream 128 will cause the repositioning of the remaining secondary content object data streams 121-126 so that, relative to the frames or thumbnail window of the screen 120 in which the secondary content object data streams 121-126 are currently displayed, each of the secondary content object data streams 121-126 either: a) move gradually from its currently displayed window to an adjacent window; b) moves in substantially instantaneously from its currently displayed window to an adjacent window, or c) the frames or thumbnail window in which the secondary content object data streams 121-126 are currently displayed actually move across the screen 120, all under any of the foregoing techniques, either to the right or to the left depending on the nature of the navigation command selected by the viewer, as illustrated conceptually by the bidirectional phantom arrow in FIG. 10 of secondary content object data streams 121-123. In this manner, the relative order of the content object data streams in the viewer's memory is maintained to facilitate more efficient and more relaxed selection of content on the right brain interface. Similarly, any of the supplemental graphic indicia associated with the content objects, such as sidebars navigation indicators or icons will similarly scroll along with the content object with which they are associated. Referring again to FIG. 8, information relevant to identification of the currently viewed primary content object stream may be displayed on-screen, either temporarily or persistently, within UI display area 120, such information including, but not limited to, any of program name, type, date of original airing, current date and time, on-air status, current viewing start time, estimated viewing end time (based on current time), duration/elapsed viewing time, and recommendation posting time and name of third-party recommender or recommendation source if other than system 35 (in the case of content recommended from a third party through a social media channel, such as Facebook, etc.). In FIG. 8, such information is indicated by the box 113 within display area 120. Such information is typically stored within data structure 111 and may be displayed upon selection of the content object for viewing as the primary content object data stream 128 or upon selection of an appropriate command button on the remote control 88 of viewer system 32. In addition, such information may be presented in various colors, fonts, formats and with a level of opacity as determined by the system designer so as not to interfere with the viewers enjoyment of the presented video data stream. Alternatively, the information designated by box 113 may be presented not on display 80, but on any of displays 84, 86, or 87 of viewer system 32, so as to avoid textual data on the right brain interface.

In a similar manner, a subset of the information typically stored within data structure 111 associated with each of secondary content object streams 121-126 may be displayed within their respective frame or thumbnail windows, such information comprising any of the information described above as displayable in box 113 and in a format similar to that described above.

Referring to FIG. 10, the lower half of UI display area 120 is illustrated, including the icon 127 representing primary content object stream 128 and the secondary content object streams 121-123. In addition to providing an area on user interface display 120 where the primary and secondary content object streams may be displayed, viewer system 32, in conjunction with the graphics engine 115, utilizes various other graphic indicia associated with each content object data stream to provide further useful information to the viewer during his viewing/surfing experience in a manner that remains essentially true to the right brain experience, i.e. with a minimum of textual information. Icon 127 represents the primary content object stream 128 and its conceptual position within the viewer channel relative to the secondary content object data streams. In an alternative embodiment, icon 127 may represent both the primary content object stream 128 and each of the secondary content object streams 121-126 displays on user interface 120 when the source of both the primary and secondary content objects is the same, for example, when all content objects are from the same broadcast or network source, icon 127 may represent the logo of such source, or, alternatively, when all content objects are from system 35, icon 127 may comprise an icon or other graphic element associated with system 135.

The positions of secondary content object streams 121-123 within UI display area 120 relative to icon 127 conceptually indicate the position of secondary content objects along a dimension of the viewer channel relative to the currently selected primary content object stream 128, and provides the viewer with a point of reference from which to navigate in the current dimension of the viewer channel or two different dimensions using the navigation controls of the remote 88, as described previously. For example, pressing the left navigation button on remote 88, e.g. “<”, will cause the primary content object stream 128 to change to the secondary content object data stream 123 to the left of icon 127. The former primary content object stream will then assume the position of secondary content object stream 124 and the other secondary content object streams will be reorder accordingly within the appropriate dimension of the viewer channel. Similarly, sequentially pressing the left navigation twice would have caused the primary content data stream 128 to change to secondary content object stream 122, with the other content objects being repositioned in order along the appropriate dimension of the viewer channel. In this manner, the viewer, using the navigational commands of remote 88, or other navigation control device as explained herein, may sequentially move through the displayed secondary content object data streams searching for a new primary content object data stream until the viewer finds content which is desirable to view. Similarly, selection of the right, e.g. “>”, navigation button on remote 88 will cause similar navigation along the same dimension of the viewer channel with the same repositioning of content objects, but in the opposite direction.

In another embodiment of the disclosed system, double-clicking of one of the navigation command buttons of remote 88 may be utilized to navigate either a chronological order of a content object from chronologically ordered content objects or a vertical fear/desire dimension. Referring to FIG. 12, for example, if a viewer is currently watching primary content object stream 128 and single clicks the left navigation button on remote 88, e.g. “<”, the primary content object stream 128 will change to secondary data content object data stream 123. As described previously, thereafter, double-clicking the left navigation button on remote 88, e.g. “<<”, rather than advancing to the newly repositioned secondary data content object data stream 122 will switch to a new nested dimension in viewer channel 90, causing the primary content object stream 128 to remain the same, however, the secondary content object data streams 121-126, previously represented by content objects 131-136 in the second dimension (time) will then be represented by content objects 141-144, respectively, representing a new dimension nested relative to the second dimension (time) and the primary content object, such as previously aired episodes of the same program. For example, if the original set of primary and secondary content object data streams as presented on UI display area 120 represented, chronologically ordered content, such as sequentially arranged unrelated programs, after double-clicking the left navigation command of remote control 88, the surfing paradigm or dimension will change so that the new set of primary and secondary content object data streams represent episodes of the same program, including previously aired episodes of the same program currently being viewed as the primary content object data stream 128, as well as, if available, any as yet un-aired episodes, which may be available on pay per view basis, as represented by streams 124-126.

The use of the double-clicking of the directional navigation control is not limited to a particular dimension, e.g. either time or association, but may be utilized to access content objects within any nested dimension associated with a current primary content object stream. In another embodiment of the disclosed system that there Is no limitation to the number or levels of nestings that may occur within a particular viewer channel. Any dimension of a channel may have multiple dimensions which may be successively accessed in a recursive manner.

In addition, the visual characteristics of icon 127 may be utilized to indicate to the viewer the status of the primary content object stream. For example, any of the color, shape, transparency, size, or other visual aspects of icon 127 may be associated with a specific parameter of the primary and secondary content object stream and may be manipulated by color, animation or in another manner, to indicate a change in the parameter value. For example, icon 127 may have a first shape or color for content objects recommended by system 35 and a second shape or color for content objects recommended by a third party or from a source other than system 35. In another embodiment, the icon or other graphic element may be used to indicate that the use or license status of the primary content object is about to change, for example, viewing more than a threshold percentage of the primary content object may automatically cause status of a content object representing a recorded broadcast program to change from “unviewed” to “viewed” or may automatically cause the purchase of content objects offered on a single or limited view basis. In such instance, the icon or other graphic element may begin to blink, pulse, modulate between colors, or change in any of shape, size, color or opacity, or may be associated with a sound or audio wave file, or any combination thereof, to indicate that a threshold condition is about to be met.

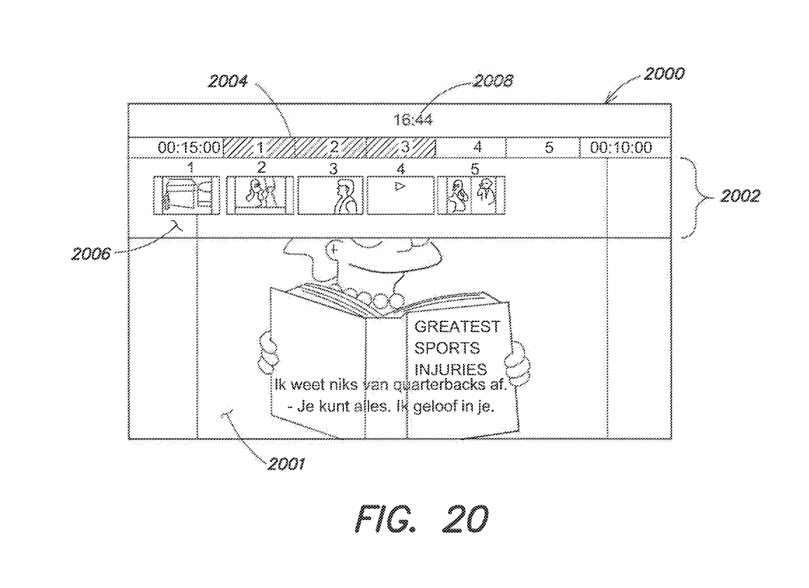

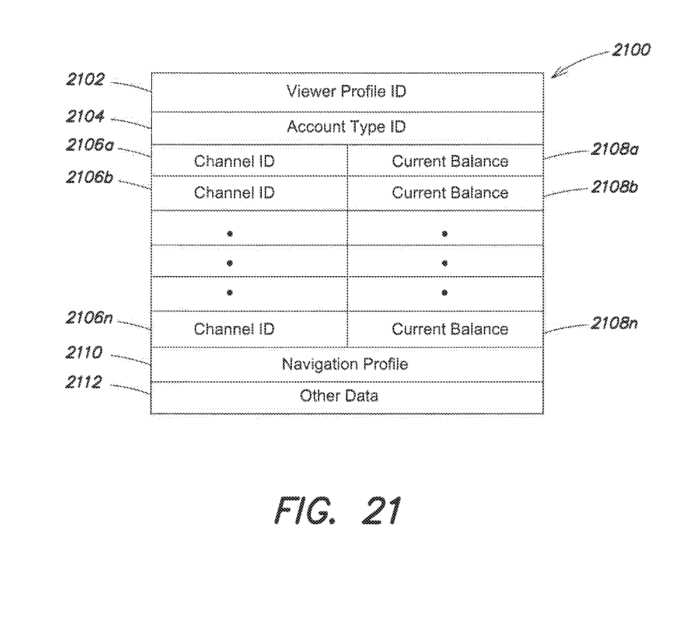

Similar to icon 127, the visual characteristics associated with secondary content object streams 121-126 may be utilized to indicate to the viewer various parameters of the secondary content object streams. For example, any of the color, shape, transparency, size, or other visual aspects of any frame or border surrounding the actual display area in which the secondary content object data stream is rendered may be associated with a specific parameter of the secondary content object stream and may be manipulated by color, shape, animation or in another manner, to indicate a change in the parameter value. Specifically, as illustrated in FIG. 10, a colored sidebar 129 associated with each of the selectable secondary content object streams indicates the license status of the content, e.g. blue for free, red for pay per view, etc. In another embodiment, each of the thumbnail frames representing selectable secondary content contains graphic indicia 139 indicating the navigational options to other queued content within a viewer channel, e.g. “̂”, “v”, “<”, “>” characters or symbols arranged around the thumbnail frame, as illustrated in FIG. 20. For example, the “̂” symbol 139a above stream 121 or 123 indicates that the viewer, once having navigated to streams 121 or 123 for viewing as the primary content stream 128, may navigate since from the currently viewed primary content stream to another content object in the first dimension (e.g. association), while the “v” symbol 139c below streams 121 or 123 indicates that the viewer may navigate to another content object in the first dimension but in an opposite direction. Similarly, the “<” symbol 139b to the left of stream 121 indicates that the viewer, once having navigated to streams 121 for viewing as the primary content stream 128, may navigate to another content object in the second dimension (e.g. time), while a “>” symbol 139d (not shown in FIG. 20) to the right of stream 126 indicates that the viewer may navigate from the currently viewed primary content stream to another content object in the second dimension, but in an opposite direction.

In another embodiment, navigational directions and commands may be used to select free content versus paid content. For example, in a vertical navigation dimension, if the viewer pushes the down arrow navigation control on remote control 88, the viewer will be presented with free content. Conversely, if the viewer pushed the up arrow navigation control, the viewer will be presented with pay (pay per view) content. As another example, in a horizontal navigation dimension, if the viewer pushes the left arrow navigation control on remote control 88, the viewer will be offered free content of a previously broadcasted program. Conversely, if the viewer pushes the right arrow navigation control, the viewer will be presented with pay (pay per view) content, e.g. content that has not yet been broadcasted and which is viewable only for a fee.

In another embodiment, navigation commands used to surf through time, desirability/fear and other dimensions may originate from display remotes having accelerometers for detecting horizontal, vertical and other gesture patterns for use as navigation and selection commands on the right brain interface and/or left brain inter face, as well as from traditional remote control 88 with a standard up, down, right, left, and enter button command set. In such embodiments, a translation program, similar to redirection application 85 is utilized to translate the outputs from a controller having either an accelerometer or gyroscope into commands which may be utilized by modeling system 35 and viewer system 32.

As noted previously, both primary and secondary content objects may be recommended from third parties or sources other than modeling system 35. The presentation format for such recommended content objects is illustrated in FIG. 11, where UI display area 120 presents a primary content object data stream 128 and multiple secondary content object data streams 121-126 of Internet content from YouTube or other Internet sources, each having been recommended by a source other than modeling system 35. The manner in which the viewer may navigate between and among the primary and secondary content object data streams 121-126 and 128 is similar as previously described herein, using navigation controls of remote 80 or other navigation input device. In the contemplated embodiment, in addition to navigating between and among the primary and secondary content object data streams, the viewer may navigate in a separate dimension among recommendation sources which may be either individuals, e.g., friends, family, etc., or specific sites on the Internet, e.g., YouTube, Facebook, etc. As illustrated in FIG. 11, a plurality of images 150, 152, and 154, representing the recommendation sources, are arranged on one UI display area 120 in a manner which allows the viewer to navigate among the recommendation sources using navigation commands from remote control 88. For example, the currently displayed set of primary and secondary content object data streams 121-126 and 128 may be associated with a recommender having an associated image 152. Use of the “up” and “down” navigation command buttons on remote 88 will allow the viewer to move from a dimension of content objects recommended by such source, to a dimension of content objects recommended by a recommender having an associated image 150.

Images 150, 152 and 154 may have frames or orders which provide additional information to the viewer, similar to that previously described with content object data streams 121-126, for example, border around the image of the currently selected recommendation source may have a different shape, color and animation than that around the other images. Similarly, the loop buffering of any secondary content object data streams may likewise be implemented with content from such recommendation sources, as described previously.

Although the system described herein is intended to be utilized to display content compiled by modeling system 35, the reader can appreciate and understand that any content object may be utilized as the initial point of the viewing experience, including commercially broadcast channels from cable providers or other sources, including one or more virtual channels as described herein, and, thereafter, using the system described herein, the user may navigate to content objects which are either compiled by modeling system 35 or recommended from sources outside modeling system 35.

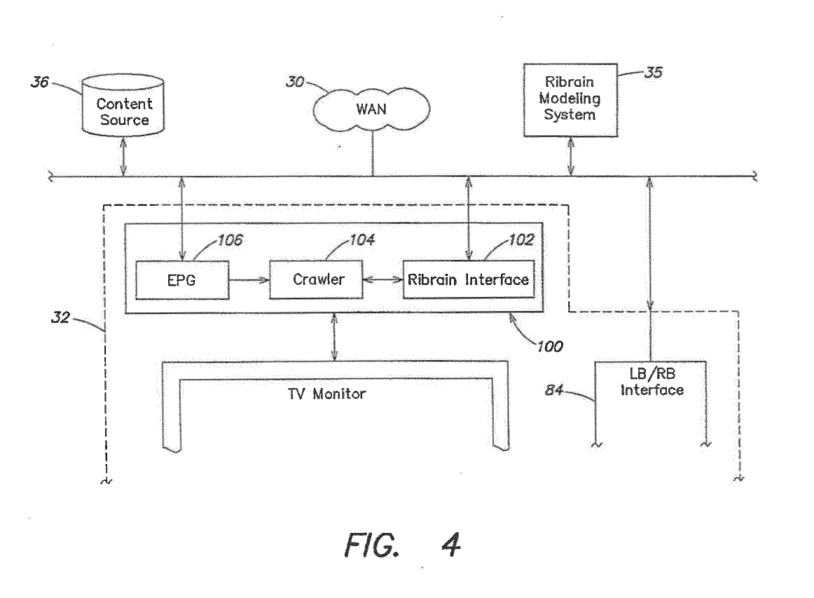

FIG. 4 illustrates conceptually selected elements of viewer interface system 32 relative to public network 30, content provider source 36 and modeling system 35 in accordance with the disclosure. The viewer system 32 comprises a first or right brain user interface display 80, used predominantly for viewing of video content which, in the illustrative embodiment, may be implemented with television display 80 and an accompanying remote control 88. Display 80 may be implemented with a “connected TV” or other devices that connect the TV to the networks 30 such as a connected Blu-ray player or a connected game console, e.g. a device capable of connecting directly to the Internet, e.g. network 30, as well as a cable packet network or satellite network, e.g. network 31. Viewer system 32 further comprises a second or left brain user interface 84 which presents a content surfing interface and purchasing interface and may be implemented on a Personal Digital Assistant (PDA) or smart phone, tablet computer or even laptop computer. Such second user interface predominantly uses and/or stimulates activity in the left hemisphere of the human brain, and also, to a limited extent, the right hemisphere of the human brain.

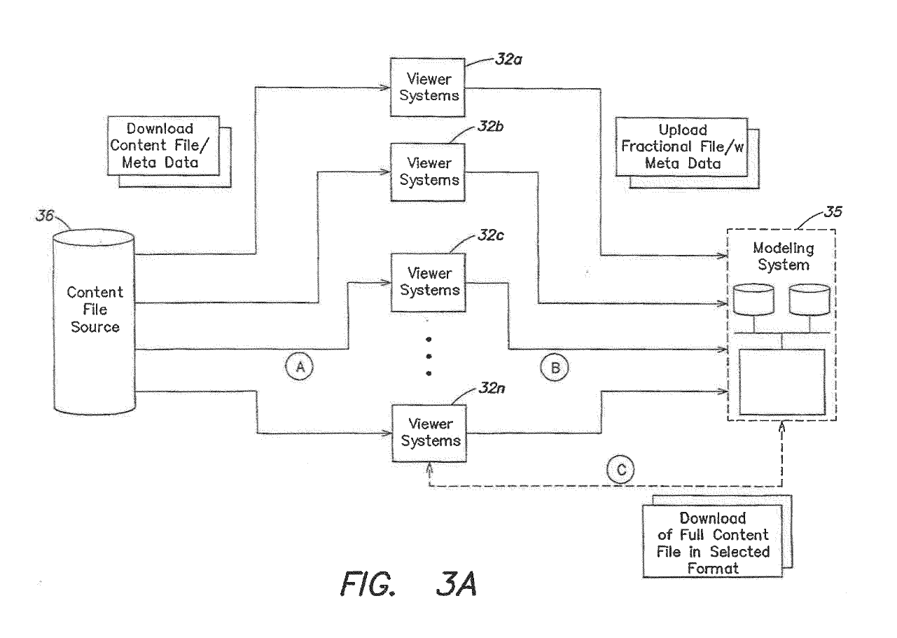

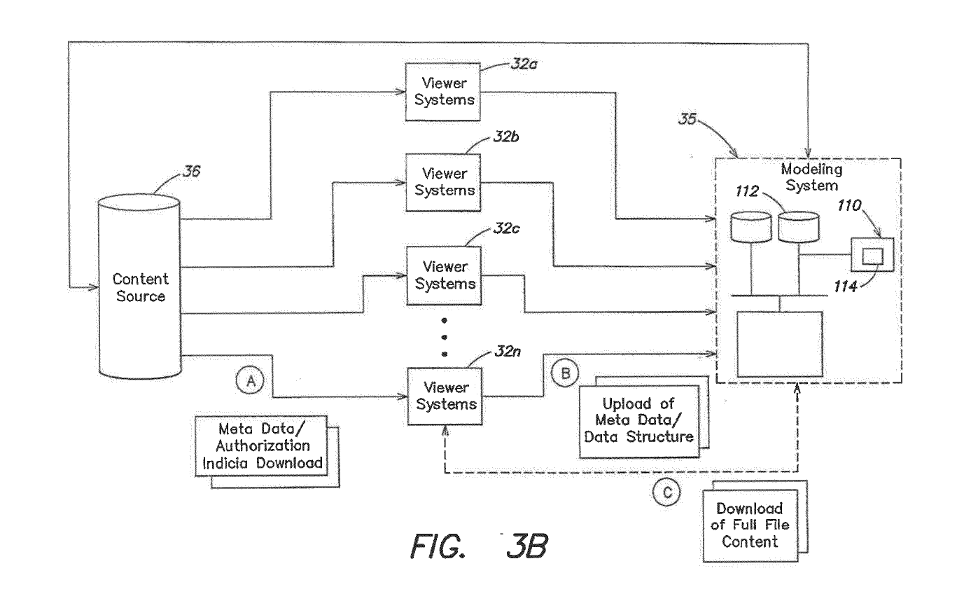

In the Illustrative embodiment, television display 80 further comprises an application process 100 for interfacing with content provider source 36 and modeling system 35. Specifically, application 100 comprises modeling system interface process 102 and crawler process 104. Modeling system interface process 102 enables viewer system 32 to interact with source 36 and modeling system 35 in a manner described hereafter with reference to FIGS. 3A-B. Crawler process 104 interacts with process 102 and content source 36, and, where applicable, a scheduling application or electronic program guide function 106 associated with content source 36 in a manner described hereafter.

Crawler process 104 interacts with content source 36 and modeling system 35, via process 102, in the following manner. Crawler process 104 continuously queries scheduling function 106 associated with content source 36 to determine which content programs are currently accessible for download streaming from the content source 36 to viewer system 32. The determination of such accessibility will typically be defined by the viewer's subscription agreement with the content source provider. Each time process 104 identifies content to which the viewer has legally authorized access, crawler process 104 initiates download streaming of the content to display 80 and buffers a fractional percentage of the content in memory associated with display 80, along with selected metadata associated with content, including data identifying the content, and one or more temporal or sequential identifiers or markers identifying the specific portion of the content contained within the buffer, as illustrated by arrow A of FIG. 3A.

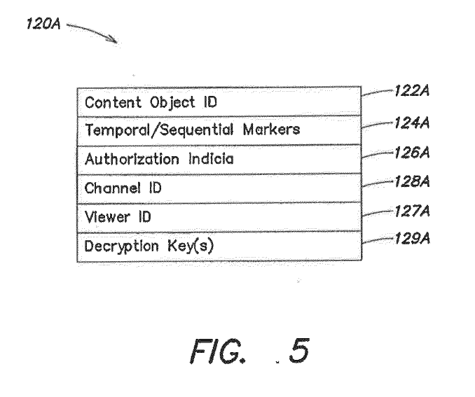

Referring to FIG. 5, in one embodiment, data structure 120A may comprise data identifying a the content object and/or a portion thereof 122A, temporal or sequential identifiers associated with the content object 124A, and authorization indicia 126A identifying a viewer process. In addition, data structure 120A may further optionally comprise data 128A identifying a user defined channel associated with the viewer process 127A and data identifying an encryption key 129A for decrypting the content object.

In the illustrative environment, the authorization indicia 126A may take any number of different forms including one or more binary values arranged in a mask, special codes, keys, hash values, etc. In addition, such authorization indicia 126A may be received from the content source 36 or may be derived therefrom by process 102. In an embodiment in which the content object from content source 36 is provided in an encrypted form, decryption keys or codes may be similarly provided to modeling system 35 by process 102 as part of the authorization indicia 126A.

The functionality performed by crawler processes 104 is repeated, continuously while display device 80 is operably connected to content source 36, for all content to which the viewer process has access. Process 104 may utilize the channel selection drivers associated with display 80 or any associated cable box 82, as applicable, to query source 36. In addition, the functionality performed by crawler process 104 occurs typically without any video or audio content being read from the display buffer to the actual display itself. In this manner, such process may be conducted while the viewer is not utilizing the system, e.g. during system “down time” and transparently without the viewer being aware.

User Interface for Presentation and Surfing of Multiple Content Objects

According to one aspect of the disclosure, a system and technique for presenting multiple, simultaneous content object data streams on a user interface is provided in a manner that facilitates surfing by the viewer in multiple dimensions. A primary content stream, representing the currently selected content object within a dimension of a viewer channel, is presented in a substantial portion of the right brain user interface display area while a plurality of secondary content object data streams, representing selectable content objects to which the viewer may navigate, are presented in smaller sized or thumbnail format in the balance of the display area of user interface. The multiple secondary content streams presented on the user interface each represent selectable content objects having a queued relationship to the currently selected primary content object data stream. Such a queued relationship may exist between and among different content object streams in the same dimension of a viewer channel or between separately selectable portions of a single content object stream or program, or between different content objects in this dimensions of a viewer channel, e.g. chronologically arranged episodes of the same program.

The process of utilizing the cursor navigation controls to perform multi-dimensional surfing of content objects within a particular viewer channel is described herein with reference to FIGS. 2A-B. FIG. 2A illustrates conceptually a multidimensional channel 90, which facilitates multidimensional surfing of content along desire and time vectors 92 and 94, respectively, using traditional cursor navigation controls. FIG. 2B illustrates conceptually the implementation of channel 90 associated with a specific subject/viewer within database 48. Channel 90 may comprise a plurality of channels 90A-C, stored in database 48 of modeling system 35.

The process by which navigation controls may be utilized to perform multi-dimensional surfing and viewing of content object streams displayed on viewer system 32 within a particular viewer channel 90 is described with reference to FIGS. 6-12 referring to FIG. 6, database 48 of modeling system 35 interacts with content database 47 or other content sources 34, 36 to ensure that a data stream representing the content object(s) within viewer channel 90 are buffered in memory associated with viewer system 32 for rendering and display on display 80.

Viewer interface system 32 comprises the right brain user interface display 80, used predominantly for viewing of video content and an accompanying remote control 88. As noted previously, display 80 may be implemented with a “connected TV” or other devices that connect the TV to the networks 30 or 31 such as a connected Blu-ray player or a connected game console, e.g. a device capable of connecting directly to the Internet, e.g. network 30, as well as a cable packet network or satellite network, e.g. network 31. FIG. 6 illustrates conceptually the relationship between the components of display 80 (in phantom), including User Interface (UI) display area 120, graphics engine 115, a primary stream buffer 116 and multiple secondary stream buffers 118a-n associated with the content objects comprising a viewer channel. Graphics engine 115 is typically part of display 80 and controls the streaming, decryption, windowing, and rendering of multiple data streams based on the content data and command/formatting data contained within the data packets associated with each stream. Buffers 116 and 118 may be implemented as segmented sections of local memory associated with graphics engine 115, or, alternatively, may be stored separately and remotely from display 80. Display 80 and viewer system 32 are connected through the network 30, represented as a cloud in FIG. 16, to modeling system 35 and the source of the content object data streams, typically any of database 34, 36, 37 or 47. A multitasking/multithreaded operating system may be used in viewer system 32 to control the streaming, buffering and rendering of the content object data stream. Specifically each stream may have associated therewith multiple threads of execution, including a thread for buffering and one or more threads for formatting and rendering the content object data on display area of display 80. As illustrated in FIG. 16, the primary content object stream has a buffer 116 associated therewith and one or more threads, labeled collectively as 117. The plurality of secondary content object streams each have a perspective buffer 118a-n associated therewith and respective sets of one or more threads, labeled collectively as 119a-n, as illustrated. In the disclosed embodiment, primary content object data stream 128 is continuously streamed from its original source via its respective buffer while secondary content object data streams 121-126 may optionally loop through a portion of their respective content, typically the first several minutes or another amount stored in each of the respective buffers. In this manner, the presentation of visual information to the viewer on UI display area 120 is more informative, particularly regarding secondary content object data streams 121-126, will efficiently using processor resources within graphic engine 115 and network bandwidth into and out of viewer system 32.

Each content object having data streamed to display 80 has associated therewith a data structure 111, as illustrated in FIG. 7, which comprises information relating to the viewable parameters of the content object, Including, but not limited to formatting parameters, status, navigation options and proprietary rights data. In addition to metadata relating to the content object, such as the object identifier, format identifier, links to other content objects within the viewer channel, the memory address where the data comprising the object is stored, and the size of the content object, data structure 111 further comprises data fields indicating the license status of the object, whether free (prepaid), pay-per-view, or pay for limited use, elapsed viewing time, whether the content object was compiled by modeling system 35, the name of someone recommending the content object, an image of the person recommending the content object, and other data necessary for representation of the various graphical elements and indicia surrounding the rendering of the content object, as explained in more detail with reference to FIGS. 18-22.

Referring to FIGS. 8 and 11, the UI display area 120 of display 80 is illustrated. Multiple content object data streams are capable of being simultaneously presented in UI display area 120. A primary content object data stream 128, illustrated in phantom, representing the currently selected content object within a dimension of viewer channel 90, is presented in the substantial majority portion of the UI display area, while a plurality of secondary content object data streams 121-126, representing selectable content objects within the viewer channel to which the viewer may navigate, are presented in smaller-sized or thumbnail format at the bottom of the UI display area 120. In this manner, the multiple secondary content object streams presented on the user interface each represent selectable content having a relationship to the currently selected primary content object stream. In FIG. 18, the plurality of secondary content object data streams 121-126, and icon 127 representing the primary content object data stream, arranged along the bottom dimension of UI display area 120, and may be associated, for illustrative purposes, with the time or second dimension is described elsewhere herein. Similarly, in FIG. 8, icon 127 and the plurality of secondary content object data streams 121-126, arranged along a side dimension of UI display area 120, and may be associated, for illustrative purposes, with the association or first dimension, as described elsewhere herein. Note that icon 127 and the secondary content object data streams 121-126 may be arranged vertically along either the left or the right side of UI display area 120. The thumbnail frames representing the content object streams of a dimension may be arranged linearly along any portion of UI display area 120 including any of the left, right, top, and bottom sides of UI display area 120. Alternatively, other arrangements of the thumbnail frames may be utilized within UI display area 120, for example circular or cluster arrangements of the thumbnail frames to provided the viewer with navigable options representative of the dimensions available for surfing relative to the currently displayed primary content object data stream 128.

Referring to FIG. 9, and as described elsewhere herein, such a queued relationship may exist between and among different content object streams or between separately selectable portions of a single content object stream or program. For example, secondary content object data streams 121-126 may represent successively ordered content objects 131-136, respectively, relative to the primary content object stream 128, which represents the currently selected content object 138 in second dimension 94 in a viewer channel 90. Alternatively, secondary content object streams 121-126 may represent successively ordered content objects representing a viewer selectable segments of the currently viewed content object in display area 120. For example, a primary content object stream representing a news program may have separately selectable secondary content object streams for program segments directed to weather, sports, business/finance, consumer reporting, etc. As another example, a primary content object stream representing the sports section of a news program may have multiple separately selectable secondary content object streams representing different video clips of sports highlights within the sports segment. In a similar manner, referring to FIG. 9, a queued relationship may exist between and among different content object streams or between separately selectable portions of a single content object stream or program. For example, secondary content object data streams 121-126 may represent successively ordered content objects 131-136, respectively, relative to the primary content object stream 128, which represents the currently selected content object 138 in first dimension 92 in a viewer channel 90. Alternatively, secondary content object streams 121-126 may represent successively ordered content objects representing a viewer selectable segments of the currently viewed content object in display area 120.

In one embodiment, secondary content object data streams 121-126 are displayed on UI display area 120 for a predetermined period of time, e.g. between 2 to 20 seconds after the last navigation command, or for some other predetermined period of time, so as not to distract the viewer from the primary content object data stream 128. Pressing of a navigation command button on the remote 88 will cause secondary content object data streams 121-126 to reappear, therefore providing the viewer with the necessary video cues to facilitate surfing among the various content objects within a dimension of a viewer channel. In another embodiment, as the viewer navigates or “surfs” among the various content objects, selection of a new primary content object data stream 128 will cause the repositioning of the remaining secondary content object data streams 121-126 so that, relative to the frames or thumbnail window of the screen 120 in which the secondary content object data streams 121-126 are currently displayed, each of the secondary content object data streams 121-126 either: a) move gradually from its currently displayed window to an adjacent window, b) moves in substantially instantaneously from its currently displayed window to an adjacent window, or c) the frames or thumbnail window in which the secondary content object data streams 121-126 are currently displayed actually move across the screen 120, all under any of the foregoing techniques, either to the right or to the left depending on the nature of the navigation command selected by the viewer, as illustrated conceptually by the bidirectional phantom arrow in FIG. 10 of secondary content object data streams 121-123. In this manner, the relative order of the content object data streams in the viewer's memory is maintained to facilitate more efficient and more relaxed selection of content on the right brain interface. Similarly, any of the supplemental graphic indicia associated with the content objects, such as sidebars navigation indicators or icons will similarly scroll along with the content object with which they are associated. Referring again to FIG. 18, information relevant to identification of the currently viewed primary content object stream may be displayed on-screen, either temporarily or persistently, within UI display area 120, such information including, but not limited to, any of program name, type, date of original airing, current date and time, on-air status, current viewing start time, estimated viewing end time (based on current time), duration/elapsed viewing time, and recommendation posting time and name of third-party recommender or recommendation source if other than system 35 (in the case of content recommended from a third party through a social media channel, such as Facebook, etc.). In FIG. 18, such information is indicated by the box 113 within display area 120. Such information is typically stored within data structure 111 and may be displayed upon selection of the content object for viewing as the primary content object data stream 128 or upon selection of an appropriate command button on the remote control 88 of viewer system 32. In addition, such information may be presented in various colors, fonts, formats and with a level of opacity as determined by the system designer so as not to interfere with the viewers enjoyment of the presented video data stream. Alternatively, the information designated by box 113 may be presented not on display 80, but on any of displays 84, 86, or 87 of viewer system 32, so as to avoid textual data on the right brain interface.

In a similar manner, a subset of the information typically stored within data structure 111 associated with each of secondary content object streams 121-126 may be displayed within their respective frame or thumbnail windows, such information comprising any of the Information described above as displayable in box 113 and in a format similar to that described above.

Referring to FIG. 10, the lower half of UI display area 120 is illustrated, including the icon 127 representing primary content object stream 128 and the secondary content object streams 121-123. In addition to providing an area on user interface display 120 where the primary and secondary content object streams may be displayed, viewer system 32, in conjunction with the graphics engine 115, utilizes various other graphic indicia associated with each content object data stream to provide further useful information to the viewer during his viewing/surfing experience in a manner that remains essentially true to the right brain experience, i.e. with a minimum of textual information. Icon 127 represents the primary content object stream 128 and its conceptual position within the viewer channel relative to the secondary content object data streams. In an alternative embodiment, Icon 127 may represent both the primary content object stream 128 and each of the secondary content object streams 121-126 displays on user interface 120 when the source of both the primary and secondary content objects is the same, for example, when all content objects are from the same broadcast or network source, Icon 127 may represent the logo of such source, or, alternatively, when all content objects are from system 35, icon 127 may comprise an icon or other graphic element associated with system 135.

The positions of secondary content object streams 121-123 within UI display area 120 relative to icon 127 conceptually indicate the position of secondary content objects along a dimension of the viewer channel relative to the currently selected primary content object stream 128, and provides the viewer with a point of reference from which to navigate in the current dimension of the viewer channel or two different dimensions using the navigation controls of the remote 88, as described previously. For example, pressing the left navigation button on remote 88. e.g. “<”, will cause the primary content object stream 128 to change to the secondary content object data stream 123 to the left of icon 127. The former primary content object stream will then assume the position of secondary content object stream 124 and the other secondary content object streams will be reorder accordingly within the appropriate dimension of the viewer channel. Similarly, sequentially pressing the left navigation twice would have caused the primary content data stream 128 to change to secondary content object stream 122, with the other content objects being repositioned in order along the appropriate dimension of the viewer channel. In this manner, the viewer, using the navigational commands of remote 88, or other navigation control device as explained herein, may sequentially move through the displayed secondary content object data streams searching for a new primary content object data stream until the viewer finds content which is desirable to view. Similarly, selection of the right, e.g. “>”, navigation button on remote 88 will cause similar navigation along the same dimension of the viewer channel with the same repositioning of content objects, but in the opposite direction.

In another embodiment of the disclosed system, double-clicking of one of the navigation command buttons of remote 88 may be utilized to navigate either a chronological order of a content object from chronologically ordered content objects or a vertical fear/desire dimension. Referring to FIG. 12, for example, if a viewer is currently watching primary content object stream 128 and single clicks the left navigation button on remote 88, e.g. “<”, the primary content object stream 128 will change to secondary data content object data stream 123. As described previously, thereafter, double-clicking the left navigation button on remote 88, e.g. “<<”, rather than advancing to the newly repositioned secondary data content object data stream 122 will switch to a new nested dimension in viewer channel 90, causing the primary content object stream 128 to remain the same, however, the secondary content object data streams 121-126, previously represented by content objects 131-136 in the second dimension (time) will then be represented by content objects 141-144, respectively, representing a new dimension nested relative to the second dimension (time) and the primary content object, such as previously aired episodes of the same program. For example, if the original set of primary and secondary content object data streams as presented on UI display area 120 represented, chronologically ordered content, such as sequentially arranged unrelated programs, after double-clicking the left navigation command of remote control 88, the surfing paradigm or dimension will change so that the new set of primary and secondary content object data streams represent episodes of the same program, including previously aired episodes of the same program currently being viewed as the primary content object data stream 128, as well as, if available, any as yet un-aired episodes, which may be available on pay per view basis, as represented by streams 124-126.

The use of the double-clicking of the directional navigation control is not limited to a particular dimension, e.g. either time or association, but may be utilized to access content objects within any nested dimension associated with a current primary content object stream. In another embodiment of the disclosed system that there is no limitation to the number or levels of nestings that may occur within a particular viewer channel. Any dimension of a channel may have multiple dimensions which may be successively accessed in a recursive manner.

In addition, the visual characteristics of icon 127 may be utilized to indicate to the viewer the status of the primary content object stream. For example, any of the color, shape, transparency, size, or other visual aspects of icon 127 may be associated with a specific parameter of the primary and secondary content object stream and may be manipulated by color, animation or in another manner, to indicate a change in the parameter value. For example, icon 127 may have a first shape or color for content objects recommended by system 35 and a second shape or color for content objects recommended by a third party or from a source other than system 35. In another embodiment, the icon or other graphic element may be used to indicate that the use or license status of the primary content object is about to change, for example, viewing more than a threshold percentage of the primary content object may automatically cause status of a content object representing a recorded broadcast program to change from “unviewed” to “viewed” or may automatically cause the purchase of content objects offered on a single or limited view basis. In such instance, the icon or other graphic element may begin to blink, pulse, modulate between colors, or change in any of shape, size, color or opacity, or may be associated with a sound or audio wave file, or any combination thereof, to indicate that a threshold condition is about to be met.

Similar to icon 127, the visual characteristics associated with secondary content object streams 121-126 may be utilized to indicate to the viewer various parameters of the secondary content object streams. For example, any of the color, shape, transparency, size, or other visual aspects of any frame or border surrounding the actual display area in which the secondary content object data stream is rendered may be associated with a specific parameter of the secondary content object stream and may be manipulated by color, shape, animation or in another manner, to indicate a change in the parameter value. Specifically, as illustrated in FIG. 10, a colored sidebar 129 associated with each of the selectable secondary content object streams indicates the license status of the content, e.g. blue for free, red for pay per view, etc. In another embodiment, each of the thumbnail frames representing selectable secondary content contains graphic indicia 139 indicating the navigational options to other queued content within a viewer channel, e.g. “̂”, “v”, “<”, “>” characters or symbols arranged around the thumbnail frame, as illustrated in FIG. 20. For example, the “̂” symbol 139a above stream 121 or 123 indicates that the viewer, once having navigated to streams 121 or 123 for viewing as the primary content stream 128, may navigate since from the currently viewed primary content stream to another content object in the first dimension (e.g. association), while the “v” symbol 139c below streams 121 or 123 indicates that the viewer may navigate to another content object in the first dimension but in an opposite direction. Similarly, the “<” symbol 139b to the left of stream 121 indicates that the viewer, once having navigated to streams 121 for viewing as the primary content stream 128, may navigate to another content object in the second dimension (e.g. time), while a “>” symbol 139d (not shown in FIG. 20) to the right of stream 126 indicates that the viewer may navigate from the currently viewed primary content stream to another content object in the second dimension, but in an opposite direction.

In another embodiment, navigational directions and commands may be used to select free content versus paid content. For example, in a vertical navigation dimension, if the viewer pushes the down arrow navigation control on remote control 88, the viewer will be presented with free content. Conversely, if the viewer pushed the up arrow navigation control, the viewer will be presented with pay (pay per view) content. As another example, in a horizontal navigation dimension, if the viewer pushes the left arrow navigation control on remote control 88, the viewer will be offered free content of a previously broadcasted program. Conversely, if the viewer pushes the right arrow navigation control, the viewer will be presented with pay (pay per view) content, e.g. content that has not yet been broadcasted and which is viewable only for a fee.

In another embodiment, navigation commands used to surf through time, desirability/fear and other dimensions may originate from display remotes having accelerometers for detecting horizontal, vertical and other gesture patterns for use as navigation and selection commands on the right brain Interface and/or left brain inter face, as well as from traditional remote control 88 with a standard up, down, right, left, and enter button command set. In such embodiments, a translation program, similar to redirection application 85 is utilized to translate the outputs from a controller having either an accelerometer or gyroscope into commands which may be utilized by modeling system 35 and viewer system 32.

According to another aspect of the disclosure, a channel may be associated with system 35 for instructional materials which the viewer to access regarding various functions and procedures associated with the system. Many broadcasters and content providers do not utilize channel “0”. In the disclosed embodiment, channel 0 is the instructional channel for system 35. For example, at any time pressing the 0 button on remote 88 will cause the primary viewing stream to switch to one or more specific content objects associated with channel 0 and their instructional content for use of the system. Alternatively, such instructional content objects may be associated with another specific channel designator or icon for display on screen 128.

As noted previously, both primary and secondary content objects may be recommended from third parties or sources other than modeling system 35. The presentation format for such recommended content objects is illustrated in FIG. 11, where UI display area 120 presents a primary content object data stream 128 and multiple secondary content object data streams 121-126 of Internet content from YouTube or other Internet sources, each having been recommended by a source other than modeling system 35. The manner in which the viewer may navigate between and among the primary and secondary content object data streams 121-126 and 128 is similar as previously described herein, using navigation controls of remote 80 or other navigation input device. In the contemplated embodiment, in addition to navigating between and among the primary and secondary content object data streams, the viewer may navigate in a separate dimension among recommendation sources which may be either individuals, e.g., friends, family, etc., or specific sites on the Internet, e.g., YouTube, Facebook, etc. As illustrated in FIG. 11, a plurality of images 150, 152, and 154, representing the recommendation sources, are arranged on one UI display area 120 in a manner which allows the viewer to navigate among the recommendation sources using navigation commands from remote control 88. For example, the currently displayed set of primary and secondary content object data streams 121-126 and 128 may be associated with a recommender having an associated Image 152. Use of the “up” and “down” navigation command buttons on remote 88 will allow the viewer to move from a dimension of content objects recommended by such source, to a dimension of content objects recommended by a recommender having an associated image 150. Images 150, 152 and 154 may have frames or orders which provide additional information to the viewer, similar to that previously described with content object data streams 121-126, for example, border around the image of the currently selected recommendation source may have a different shape, color and animation than that around the other images. Similarly, the loop buffering of any secondary content object data streams may likewise be implemented with content from such recommendation sources, as described previously.

Although the system described herein is intended to be utilized to display content compiled by modeling system 35, the reader can appreciate and understand that any content object may be utilized as the initial point of the viewing experience, including commercially broadcast channels from cable providers or other sources, including one or more virtual channels as described herein, and, thereafter, using the system described herein, the user may navigate to content objects which are either compiled by modeling system 35 or recommended from sources outside modeling system 35.

### Explicit Viewer Feedback and Personalization

In addition to the implicit feedback detectable from a viewer's selections and viewing habits, the disclosed system also affords the opportunity to provide explicit feedback to the recommendation system in a manner which requires little left brain activity. Specifically, traditional navigation controls originating from display remotes, e.g. specifically colored coded controls, may be utilized to provide explicit feedback to the recommendation system in a manner which requires little left brain activity. Selection of different color coded buttons may be used to associate each of a negative or positive valence emotion with the instances of a certain recurrently broadcasted content (e.g. a series) and/or its metadata. In addition, selection of a different color coded control may be used to socially share the link to the currently viewed content with the applicable social networks or to provide a gratuity to the author(s) of the content currently viewed or to the recommender of that content.

More specifically, as part of the disclosed system and technique for relaxed TV viewing, the command controls 240-246 of a typical TV remote 88 or other device are given new functions. The existing typical remote control command controls are part of the available interface hardware and therefore pose a minimal set-up and learning curve effort to use. The new functions that are associated with the existing command control are chosen based on the disclosed neuropsychological modeling technique to support the natural relaxing TV experience. A description of command controls and their assigned operation, based on the neuropsychological modeling technique are given below.

As illustrated in FIG. 13, selection of a first colored control 240, e.g. a red button, may be used to associate negative valence emotion with the instances of a certain recurrently broadcasted content (e.g. a series) and/or its metadata. Such negative valence emotion association may result in that particular recurrent content not be scheduled in a personalized channel and/or a time-shifted content list and therefore the content is not recorded for that user. This can be implemented as the red button meaning: “Do not record for time shifting purpose for my profile anymore”. The user can indicate using the red button of the remote control that he or she no longer wishes to record a certain program. When pressing the red button while positioned on a program, its representation remains in the navigation bar until navigation to another program*, then:
the program will no longer be shown in the part of the horizontal navigation bar that lists the recorded programs**
the program is still shown as a thumbnail in the future part of the horizontal navigation bar
the program is shown in the “live” part of the horizontal navigation (at the time it is broadcasted)
   *navigating away can be due to a remote control action by the user or because the program was played until the end and the next program started to play
   If a program that was red marked is shown in the navigation bar then a symbol representing the red button of the remote control is shown in the lower right corner of the thumbnail.
   If it is a program with a recurring nature (e.g. episode of a series) or the program is repeated (i.e. same episode is broadcasted again) then the behavior described above applies to all occurrences of that program.
   **when using the calendar to select a day in order to view all programs broadcasted that day then the red marked programs of that day are shown in the horizontal navigation bar.
   When positioned on a program that was marked using the red button of the remote control the program metadata is displayed in the upper left corner in color red. Next to the program metadata a symbol representing the red button of the remote control is shown.
   A message is shown to inform the user that the program was marked with the red button (indicating the user no longer wishes to record that program) and that this can be undone by using the blue button.

Selection of a second colored control 242, e.g. a blue button, may associate positive valence emotion with the instances of a certain recurrently broadcasted content (e.g. a series) and/or its metadata. Such positive valence emotion association results in that particular recurrent content being scheduled in a personalized channel and/or a time-shifted content list and therefore the content is recorded for that user. This can be implemented as the blue button meaning: “Do record for time shifting purpose for my profile”. When positioned on a red marked program (i.e. either as a live or as a future program) using the blue button of the remote control a user can indicate that he/she wishes to record this program again. The metadata in the upper left corner may appear back in white and a message is shown to inform the user of his action.

Selection of a third colored control 244, e.g. a yellow button, may socially share the link to the currently viewed content with the applicable social networks. The applicable social networks may be Facebook, LinkedIn. Twitter, blog, email or other. A practical implementation may be a preformatted email or other electronic message that is sent from a general or personalized account to a user predetermined account, which may be his own account, for manual processing and actual publishing or communication or an account which causes the publishing or communication to occur automatically.

Selection of a fourth colored control 246, e.g. a green button, may associate gratitude with the author(s) of the content currently viewed or to the recommender of that content. Such gratitude may have as a result the donation of gratuity or thank you fee. The distinguisment between author and recommender may be made based on the home content of a recommendation channel being viewed or the recommended content itself or may be based on a simple iconic viewable interface popping up after the button has been pushed. The amount of gratuity can be pre-set automatically and changed based on a left brain interface as part of the TV tandem interface. The backend payment and management system is created in order to manage correct and confidential management of author, recommender and service provider (the license holder to this patent) credentials. In case donations are not correctly attributable to authors or recommender, they can flow to a non-profit fund.

Alternatively, using the green button of the remote control a user can add a program to his or her “favorites” channel (see “favorite channel”). The metadata displayed in the upper left corner is marked in color green. Next to the program metadata a symbol representing the green button of the remote control is shown. A message may be shown to inform the user of his or her action. If a program that was green marked is shown in the navigation bar then a symbol representing the green button of the remote control may be shown in the lower right corner of the thumbnail.

Explicit right brain feedback becomes even more powerful when the red and blue button are not just specified in association with a particular content object, but with one or more metadata values associated with the content object. For example, in embodiments, when the viewer presses the red button or specifies an equivalent command during viewing of a specific content object, then the metadata associated with that content object may be visually displayed at the bottom of the screen, e.g. a menu bar. Such bar may show a picture of the leading actor, e.g. Jack Nicholson, next to a graphic representation characterizing a genre, e.g. horror movie, etc. The user can then select what in particular he likes or dislikes about the content object using the explicit feedback buttons or commands and thereafter, the fear and desire components related to the selected metadata are subsequently updated accordingly.

It will be obvious to those reasonably skilled in the art that variations of the above described system and technique may be utilized. For example, there does not need to be a specific one to one correspondence between controls and the type of explicit feedback provided from the viewer to the recommendation system. For example, instead of one button for each of the described feedback types, a two-position rocker switch may be utilized in which one position is used to designate a negative valence emotion with content and/or its metadata while the other position is used to designate a positive negative valence emotion with content and/or its metadata. Also, a control itself need not be colored but could have a color designation of any shape, color, graphic pattern or image affixed thereto. In addition, the choice of colors, patterns or images may be at designer's discretion. Further, any physical control on either the remote 88 or a virtual control on the user interface such as a PDA or laptop through which the viewer communicates with the primary right brain display 80, may be utilized, including the traditional navigation cursor controls in a configuration allowing for multi-mode functionality, as well as traditional keyboards, gesture recognition user interfaces or voice command user interfaces.

### Video Navigation

### Channel Navigation

According to another aspect of the disclosure, an interface system for presentation of object contents includes various enhancements to create a more relaxed viewing experience. In embodiments of the disclosed system, different types of channels exist: “natural” channels, corresponding to a TV broadcast channel, and “virtual” channels, containing video content from different sources selected according to a certain criteria e.g. genre, user favorite, etc.

Both natural and virtual channels may be accessible in similar manners through the proposed interface system, e.g. using either the number buttons or using the channel up/down button on the remote control 88.

If the channel with the selected number does not exist, the channel with the nearest number is selected. If two channels are nearest to the input number then the one with the highest number is selected.

When selecting a channel the video starts to play from the position within the program that was last watched within that channel for more than 15 seconds within a viewing session, otherwise play starts from the “live” position.

At startup, video play starts from the position last watched by the user during the previous viewing session, e.g. in the channel and at the position within the program last watched by the viewer for more than 15 seconds before shutting down the application. If the program no longer exists, e.g. due to the fact that its expiration date has passed, then video play starts at the “live” position of the channel. If such a position does not exist playback starts at the “live” position of the first channel. Pressing a designated “back” button on the remote 88 results in navigation to the program watched before for more than 15 seconds during a viewing session, e.g. after starting the application.

Navigation within a Channel

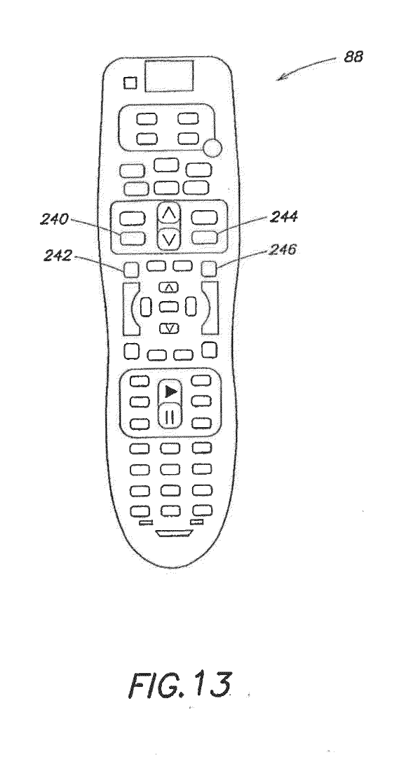

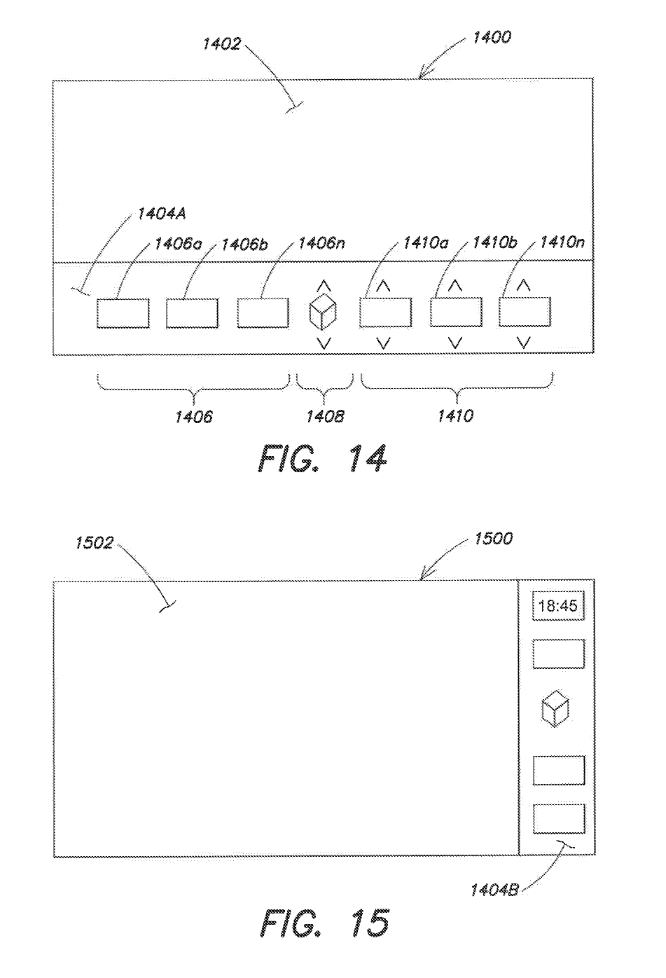

As illustrated in FIG. 14, the user interface 1400 comprises a main viewing area 1402 and a navigation bar 1404. Within the content of a channel, a viewer/user can navigate in two dimensions, e.g., horizontal and vertical, using navigation bar 1404, which has a horizontal navigation bar configuration 1404A and a vertical navigation bar configuration 1404B. The content of the navigation bar 1404 depends on the type of channel and the program context As illustrated in FIG. 14, navigation bar displays a number of “thumbnails”, each thumbnail representing a program. Using the directional commands, e.g. directional arrow keys left and right of a remote control device, the user can navigate through various content available.

In one embodiment, the navigation bar 1404 contains three sections: a recorded programs section 1406, a live programs section 1408, and a future section 1410. In one illustrative embodiment, the navigation bar 1404 may be arranged as follows:
A left-most section 1406 that lists recorded programs in a certain order depending on the type of channel, e.g. for a natural channel this may be the chronological order from left to right, with the program that was broadcasted earliest is most to the left
A center section 1408 that lists the “live” broadcasted program(s), if one exists
A right-most section 1410 that lists future programs in a certain order, e.g. chronological order for a natural channel.

Up and/or down arrow symbols, displayed above and below the thumbnails in the various sections of the navigation bar 1404, indicate to the user that he/she can use the up and/or down arrow keys of the remote control 88 to access a vertical dimension using the vertical configuration of navigation bar 1404B, as illustrated conceptually in FIG. 15. The content and functionality of the vertical navigation bar 1404B depends on the type of channel and the program context of the thumbnail from which the navigation action started.

Recorded Programs

Previously recorded programs may be listed in the horizontal configuration 1404A of navigation bar 1404 for a certain period of time, e.g. 30 or more days, depending on the type of channel. After such period programs may no longer be listed. As illustrated in FIG. 14, each thumbnail 1406a-n in the recorded programs section 1406 of horizontal navigation bar 1404A may display an image that corresponds to a video frame of the recorded program, e.g., at the mid position of the content object comprising the program. For recurring programs, e.g. episodes of a series or the daily news, only the instance of the program that was broadcasted most recently for a season, maybe listed in the horizontal navigation bar. If a program is repeated, e.g. an episode of the instance of a program, and is broadcasted again within the time window of the recorded programs part, the first occurrence is kept in the horizontal navigation bar 1404A.

Programs which the user/viewer indicated that he/she no longer wishes to record may not be listed in section 1406 of the horizontal navigation bar 1404A, unless the user is watching them.

If the recorded program represented by one of thumbnails 1406a-n is a recurring program then the arrows down and/or up associated with the thumbnail will be displayed in case previous recorded and/or future (to be broadcasted) episodes exist—relative to the current episode—within the time window allowed for respectively the recorded and future programs part. These episodes are listed in vertical configuration 1404B of navigation bar 1404 from oldest episode, e.g., lowest on the bar, to the episode furthest in the future, e.g., highest in the bar, relative to the current episode, as illustrated in FIG. 15. By using the directional commands on the remote 88, e.g., the up and down arrows keys, the viewer may navigate through the thumbnails the viewer can navigate through the various content represented by thumbnails 14 06a-n of vertical navigation bar 1404B.

Live Programs

If there is a live broadcasted program it is listed at all times in section 1408 of navigation bar 1404. Selection of the icon representing section 1408 results in display of the vertical configuration 1404B of navigation bar 1404 similar that illustrated in FIG. 15. As illustrated in FIG. 15, the user interface 1500 comprises a main viewing area 1502 and a vertical navigation bar 1404B. Each thumbnail shown in FIG. 15 may correspond to the image of a video frame at the start or at the mid position of the program, depending if the moment of live broadcast is before or after the mid of the program. The live broadcasted program is the “pivot point” in the vertical navigation 1404B. If it is a recurring program and previous recorded programs exist then an arrow down is also displayed. Navigating in the downward direction using the remote control navigation keys, the user can navigate through the thumbnails displayed on the vertical navigation bar representing a listing of previous recorded and/or future episodes of the live broadcast program, similar to the navigation up/down from thumbnails in the recorded programs part. An arrow up is displayed at all times on the vertical navigation 1404B and allows navigation in a vertical navigation bar. In case of a natural channel, selection of the vertical navigation bar configuration displays the calendar functionality of the interface 1400, as described herein.

Future Programs

Referring again to FIG. 14, still to be broadcasted programs, are listed in the section future section 1410 of the horizontal navigation bar 1404A for a predetermined period of time, e.g. 14 days. Beyond this period, such programs may no longer listed on the interface 1400. Each thumbnail 1410a-n, shown is the image of a digital clock that indicates the time the program will start. For programs that are not broadcasted within the current day, the day is also listed. For future programs a mirroring of the rules for recorded programs may be as follows:
For recurring programs, the first episode that will be broadcast in the future is shown
Only the first occurrence of a repeated program is shown
   One exception: programs that are not recorded for the user—based on his marking with the red button—are listed with a symbol that indicates that they will not be recorded to allow the user to change the recording settings. The thumbnails of future programs 1410a-n are displayed with an arrow down and up at all times. By using the up and down arrow keys of the remote control, the user can navigate a vertical navigation bar representing the calendar week view, as described herein.

### Calendar

A calendar function is accessible from the live section 1406 and future section 1408 of the horizontal navigation bar 1404B in a natural channel. The calendar function allows the viewer to navigate straight to a specific day. If the user/viewer selects a day then all programs broadcasted that day may be listed in the horizontal navigation bar, including repeats, episodes of series that are not the latest episode, and programs marked ‘not to record’.

As illustrated in FIGS. 16-17, the calendar function generates the a display 1600 comprising a main viewing area 1602 and navigation bar that 1604 that comprises two navigation bars, a vertical week view bar 1604A, listing weeks sequentially in chronological order, e.g., oldest down to furthest in the future up, and a horizontal week view bar 1604B, listing the days of a selected week sequentially in chronological order, e.g., from left to right. The vertical week view bar 1604A is accessed from the “live” thumbnail in live section 1408 of horizontal navigation bar 1604A or from one of thumbnails 1410a-n in the future section 1410 of horizontal navigation bar 1404A, using the directional command arrow keys of the remote control 88.

As illustrated in FIG. 17, the calendar function generates the a display 1700 comprising a main viewing area 1702 and a horizontal week view bar 1604B. In vertical week view bar 1604B the weeks represented by thumbnails 1604c-n are listed relative to the week containing the broadcast day of the program associated with the thumbnail from which the calendar was accessed. When navigating with the vertical week view, e.g. “up” to the next week or “down” to the week before, the video of the corresponding program is started immediately. The corresponding program is defined as the program that was (or will be) broadcasted on the same “day of the week” and at the same “time”—but in the selected week—as the program associated with the thumbnail from which the navigation started.

Navigating left or right from a thumbnail in the vertical week view bar 1604A navigates to the horizontal week view bar 1604A. The days listed in the horizontal week view bar 1604B are relative to the broadcast day of the program associated with the thumbnail from which the horizontal week view bar 1604B was accessed, e.g. “left” navigates to the day before and “right” navigates to the day after.

When navigating with the horizontal week view bar 1604B, the video of the corresponding program is started immediately. The corresponding program is defined as the program that was (or will be) broadcasted in the same week and on the same time—but of the selected day—as the program associated with the thumbnail from which the navigation started.

Visibility of Navigation Bars

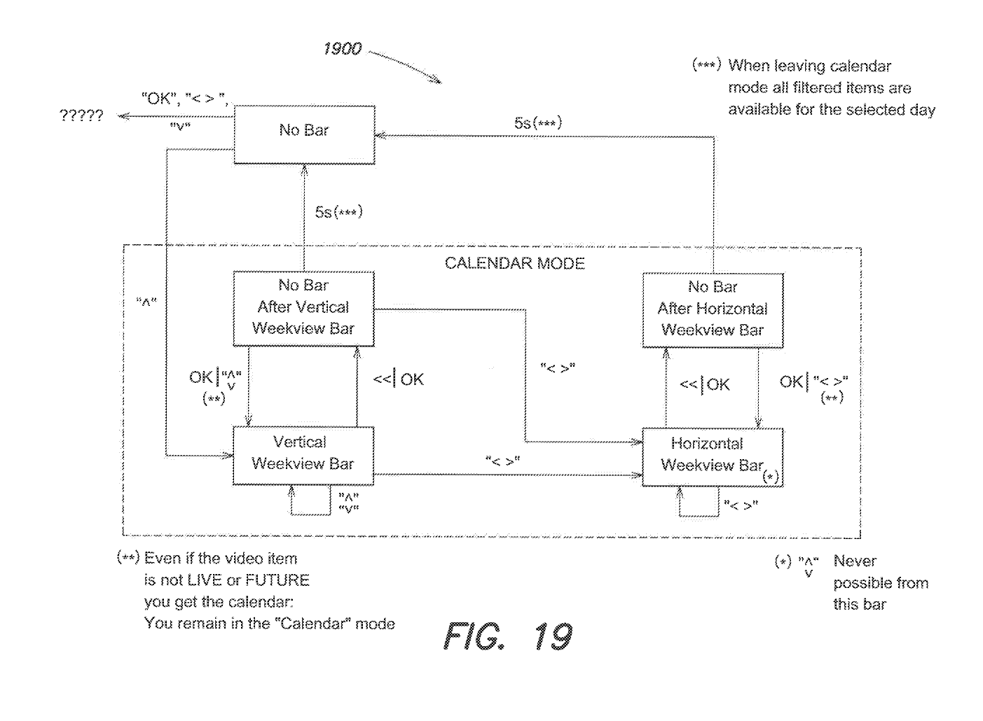

FIGS. 18-19, conceptually Illustrate state diagrams of the navigation bar schema which may be embedded into an executable module or application running within the systems disclosed herein. FIG. 18 illustrates conceptually the navigation bar state diagram, 1800 for the recorded section 1406 of navigation bar 1404. FIG. 19 illustrates conceptually the navigation bar state diagram 1900 for the calendar (live part) section 1408 of navigation bar 1404.

Referring to state diagram 1800 of FIG. 18, in an illustrative embodiment, a navigation bar is displayed each time an arrow key of the remote control 88 is pressed. The type of navigation bar may be any of navigation bars 1404A-B, 1604A-B, and 2002 depending on the context at the time the remote command was received. The “OK” button of the remote control 88 may toggle the visibility of navigation bar. If there is no navigation bar, when pressing “OK” on the remote control, then the following protocol may apply:
If there was a navigation bar before that disappeared less than 5 seconds ago, then that particular navigation bar is shown (can be horizontal or vertical)
If there was a navigation bar more than 5 seconds ago, then the horizontal configuration 1404A of navigation bar 1404 is shown
   If there is a navigation bar 1404 visible and “OK” is selected on remote 88, then the navigation bar 1404 disappears. In one embodiment, after a predetermined period of time, e.g. 5 seconds, of display, the navigation bar 1404 disappears automatically.

Live Button

Pressing the “live” button on the remote control 88, results in navigation to the “home” position of a channel. For natural channels, the protocol may be as follows:
If a program is broadcasted live then the video for this program starts to play from the near live moment
If there is no program broadcasted live then the user is positioned on the first thumbnail of the next episode in future segment 1410 of navigation bar 1404

For virtual channels the protocol may be as follows:
In a virtual channel multiple programs can be “live” broadcasted at the same time, since the virtual channel can source programs from multiple natural channels; if multiple programs are live then the “home” position is defined as the program that started last; if multiple programs started at the same time then the program that is broadcasted by the channel with the lowest channel number may be selected, with the video of such program being played from the start of the program
If there is no program broadcasted live then the user is positioned on the first thumbnail in future segment 1410 of navigation bar 1404

### Program Information

Base Metadata

When navigating to a program on displays 1400, 1500, 1600 or 1700, or pressing “OK” on the remote control 88, the base metadata of the program is shown in the main display portion 1402, 1502, 1602 or 1702 of displays 1400, 1500, 1600 or 1700, respectively, and may comprise any of: title, subtitle (if one exists) and date/time when the program is broadcast, as well as other information. For live broadcast programs, the end time of the program is shown in either remaining time or local time format. For recorded programs, the total duration is shown together with the end time of the program, in either remaining time or local time format, if watching continued from the current position in the video stream.

List Button

When pressing the “list” button of the remote control the user is presented with extensive metadata associated with the program: genre, subgenre, producer, cast, description, synopsis rating etc.

### Video Control

Chapter Bar

Referring to FIG. 20, in addition to the various navigation bars described herein, a chapter thumbnail bar 2000 displays for the user/viewer his/her position within the program, comprising the content object being viewed during video control actions, e.g. play, pause, forward or rewind, chapter navigation (back and or forth) and slow play. As illustrated in FIG. 20, a display 2000 comprises a main display area 2001 and a chapter thumbnail bar 2002 comprising a duration of bar 2004, which represents the total duration of the program and is divided in numbered segments that represent “chapters” in the program, a navigation bar 2006 divided into a number of thumb nails which represent chapters within the currently viewed program, and a time display 2008.

Within duration bar 2004, progress is indicated on the bar in a color, e.g. dark blue, that represents the current position of the video from the beginning relative to the total duration of the program. An optional time display at proximate one and the duration bar 2004 indicates the duration of video play between the start of the program and the current position in the video, while an optional time display proximate the other end duration bar 2004 indicates the duration of video play between the current position and the end of the program.

For programs that are live broadcast a progress bar, similar or dissimilar in format to bar 2004 may indicate the current position of the near live broadcast As illustrated in FIG. 20, below the duration bar 2004, navigation bar 2006 displays a number of thumbnails, each of which correspond to a chapter in the program, e.g. the thumbnail image shown corresponding to the video frame at the position of the chapter. An identifier, typically a number, of the corresponding chapter is shown above each chapter thumbnail. The thumbnail corresponding to the chapter that contains the current position of the video is replaced with a symbol that represents the video control action. The optional time display 2008 displays the elapsed time from the start of the program to the currently displayed video frame in the current chapter. The following subsections explain the behavior of the chapter bar 2002 for the described actions.

Play

When pressing the “play” key on the remote control 88, the following algorithmic protocol may be implemented:
the video starts to play if it wasn't playing or continues play if it was playing already
if the chapter thumbnail bar 2002 was not visible before, it is shown on top of the video
if the chapter thumbnail bar 2002 was visible before it disappears

When the video is playing the chapter thumbnail bar 2002, may disappear automatically after a predetermined time, e.g. 5 seconds. If the chapter thumbnail bar is visible and the position of the video play changes from one chapter to the next, the chapter thumbnails are animated accordingly to reflect any updated status.

Pause

When pressing the “pause” key on the remote control 88, the following algorithmic protocol may be implemented:
the video is paused if it wasn't paused or remains in the paused state if it was paused already
if the chapter thumbnail bar 2002 was not visible before it is shown on top of the video
if the chapter thumbnail bar 2002 was visible before it disappears

When the video is paused the chapter thumbnail bar 2002 does not disappear automatically. When the video of a live program is paused, the progress bar may continue to display the progress of the live broadcast, even though the video is paused.

Forward or Rewind

When the video is playing and a “forward” or “rewind” command is entered on the remote control 88, the following algorithmic protocol may be implemented:
the video is forwarded or rewinded in predetermined increment steps, e.g. 10 seconds
pressing “forward” or “rewind” again respectively increases or decreases the speed, e.g. the speed is changed in the steps, incremental steps: −20 minutes, then −10 minutes, then −5 minutes and −60 seconds, then −20 seconds, then −10 seconds, then 10 seconds, then 20 seconds, then 60 seconds, then 5 minutes, then 10 minutes, then 20 minutes
the chapter thumbnail bar 2002 only shows two thumbnails: on the left the thumbnail of the current chapter is shown, on the right the thumbnail the next chapter is shown; in between these thumbnails the symbol for forward or rewind is shown together with the speed of the action

The chapter thumbnail bar 2002 remains visible as long as the video play mode is in forward or rewind. When the video is alive program in forward mode, as the video reaches the near live moment the video starts to play at normal speed. When the position of the video play changes from one chapter to the next or previous chapter, the thumbnails are animated accordingly to reflect any respective updated status.

Slow Play

When the video is paused and the “forward” or “rewind” key is pressed on the remote control 88, the following algorithmic protocol may be implemented:
the video is forwarded or rewinded at a predetermined speed, e.g. 0.5 seconds
pressing “forward” or “rewind” again is only allowed if it is the same action as before; this changes the speed in direction “forward” or “rewind” according to the following incremental steps: 0.5 seconds, then 0.2 seconds, then 0.1 seconds, then 0.03 seconds
in the chapter thumbnail bar 2002, all thumbnails are shown but the thumbnail corresponding to the chapter that contains the current position of the video is replaced with a symbol for forward or rewind together with the speed of the action.

The chapter thumbnail bar 2002 remains visible as long as the video is slow playing. When the position of the video play changes from one chapter to the next or previous chapter the thumbnails are animated accordingly to reflect any updated status.

Chapter Navigation

When pressing the next or previous key on the remote control 88 while the chapter thumbnail bar 2002 is displayed, the video jumps to the position of the next or previous chapter, as appropriate. Video play depends on the previous state of the video play:
when the video was previously playing, the video plays further from the position of the selected chapter.
when the video was previously paused, video play remains paused at the position of the selected chapter.
when the video play was in forward, rewind or slow playing mode, the video plays further at normal speed from the position of the selected chapter

Continuous Play

When a program ends, the next natural program starts to play automatically. The “next natural program” is the program that was broadcasted sequentially on the same channel after the just ended program. Moreover, when using rewind, slow play in rewind direction or previous chapter beyond the program start, the action is applied to the “previous natural program”, i.e. the program that was broadcasted sequentially before the program on the same channel. Similarly, when using fast forward, slow play in forward direction, or next chapter beyond the program end, the action is applied to the “next natural program” and so on. When the user is positioned on a future thumbnail in the horizontal navigation bar 1404A, the program starts to play as soon as the program of the thumbnail becomes the “live” program.

### Virtual Channels

Theme Channel

A “theme” channel sources content from the programs of all natural channels that satisfies a certain criteria, e.g. all movies or a certain genre and/or subgenre, a keyword entered by user, e.g. westerns, martial arts, etc. The structure of a horizontal navigation bar for a theme channel is similar to that of horizontal bar 1404A of a natural channel, with one extra specification when dealing with content from multiple channels: programs are ordered by start time, e.g. oldest is most to the left; if two programs start at the same time then channel ordering may be followed, e.g. highest channel number is most to the left.

A vertical navigation bar, similar to that of vertical bar 1404B that lists the logos of all natural channels from which content was sourced in the theme channel, is available from live section thumbnails, by for using directional commands, e.g., the “up” arrow and from the future section thumbnails using arrow keys “up” and “down” of the theme channel horizontal navigation bar. Using such a navigation bar, the user can select a channel that is used as a filter, i.e. only content sourced from that channel as listed in the horizontal navigation bar. The continuous play principle applies for programs in a theme channel.

Favorites Channel

Favorites channel is a special “theme” channel that sources all content designated by a user, e.g. with the “green” button. If the program selected is part of a series, all instances of the series are selected. Any occurrences of the program or any instances of its series on other channels than the natural channel where such program was marked “green” are also selected. If the user hasn't selected anything yet then a poster with green background and the “favorites” symbol is shown. A message is shown to inform the user of the channel usage. For the future section 1410 of the navigation bar 1404 associated with a favorites channel, a green color scheme may be used instead of the usual blue color scheme.

In one embodiment, with a specifically designated control, e.g., a yellow button on the remote, a user can share a program with friends from his/her social network. The metadata displayed in the upper left corner of display 1402 may be marked in a color, e.g., yellow. Next to the displayed program metadata, a symbol representing the yellow button of the remote control may be shown along with a message to Inform the user of his/her action. If a program that was yellow marked is shown in the navigation bar 1404 then a symbol representing the yellow button of the remote control may also be shown in the lower right corner of the thumbnail.

Social Channel

All programs that are shared by a user's “friends” of a certain social network, e.g. friends on Facebook, people followed on Twitter, etc., using the “yellow” button of the remote control are listed in a separate “social” channel for that network. With the social channel, the structure of the horizontal navigation bar is analogue to the structure of a theme channel, except:
If a program that was red marked (do not record) by the user, is shared with him by a friend then it is shown in the horizontal navigation bar with a symbol representing the red button of the remote control in the lower right corner of the thumbnail
the recorded programs are shown in the order of the time that they were shared, e.g., latest shared is shown at the rightmost position

A vertical navigation bar 1404B that lists the groups of friends from which content was sourced is available from the live section 1408 thumbnails using the “up” arrow and from the future section 1410 thumbnails using arrow keys “up” and “down” of the horizontal navigation bar 1404. Using this navigation bar the user can select a friend group or an individual friend that is used as a filter, e.g. only content shared by friends of that group is listed in the horizontal navigation bar. Note, using the red button in the “favorites” channel removes the program and related instances from the “favorites” channel and not from the other channels.

### Profiles

All positions of programs watched and programs marked with a special status are associated with a “profile”. A user can select from a number of different profiles identified with a number in order to personalize the experience for a certain context, e.g. young family member, business, time of day, etc. By default, when starting, the interface application uses the profile with identification number 1.

Switching the profile is done by pressing a button of the remote control 88, e.g. a button marked “enter”, and entering the number of the selected profile. The number shown when pressing the “enter” button is the number of the current profile.

### Profile Passwords

In an illustrative embodiment, all profiles with identification number other than “0” or “1” are password protected. When accessing a password protected profile and a password has not yet been set for such profile, e.g. first time access of the profile, the user may be asked to enter a password, e.g. of maximum 10 digits long, using the numbers of the remote control and to reconfirm such password. When accessing a password protected profile that already has a password, the password is prompted before switching to the password protected profile. If the password is incorrect, the user remains in the previous profile.

### Parental Control

For profiles that are not password protected, all content that is not suitable below a certain age, e.g. defined based on parental rating standard categories such as VCHIP, MPAA, DVB, will be marked as “not to record” by default, similar as if marked with the red button. When a user encounters such a program, e.g. as the live program or on a future thumbnail, he/she is informed with a message that they can mark the program as “to record” again using a designated button, e.g., blue, of the remote control 88. The viewer will then be prompted to confirm that he/she meets the required age.

### Commercial Ad Time Shifting

According to another aspect of the disclosure, a system and technique uses advertisement accounts for some or all of its TV user accounts and broadcasters. For TV viewers, advertisement should not disturb the natural relaxing nature of the TV viewing experience. Therefore being able to watch advertisements of interest when desired is a design imperative for the relaxing TV experience.

Such relaxed TV viewing experience can be achieved by simply skipping the viewing of TV commercials or other advertisement. Since advertisers pay for the free or reduced cost viewing of consumers, this solution does not satisfy interests of the supply side of the market. However a solution can be devised that reduces the frustration of the TV viewer, while at the same time protecting the value created for advertisers and broadcasters, since not frustrating the viewer is the value creation mechanism for the advertiser, on the contrary.

For advertisers and broadcasters, a TV commercial or other advertisement is more valuable if it is more personalized to the interest of the viewer, when the viewer watches it at his/her own convenience, in a relaxed mood, when the viewer pulls the advertisement rather than that the advertisement is pushed to the viewer and of course if the TV user actually watches the advertisement, instead of simply taking a break.

The proposed credit model takes these value creation parameters into account, by crediting an advertisement account. For each viewer or viewer profile or each family or home or other group validly subscribed, combined with each broadcaster or group of cooperating broadcasters, a separate advertisement profile account is kept. Each advertisement account is credited using the advertiser value credits model, potentially but not necessary including a value payment system to credit the advertisement account.

Such same advertisement account may then be debited according to the following rules. The fast-forwarding of an advertisement by a viewer or viewer group, or the automatic skipping of an advertisement, leads to a lowering of the credits on the viewer or viewer group's advertisement account with that broadcaster or group of broadcasters, based on a cost or selling price model or based on an advertiser value model, or a combination of both.

If a viewer or group of viewers watches an advertisement, the credits on the viewer's or viewer group's advertisement account with that broadcaster or group of broadcasters increase based on an advertiser and/or broadcaster value model. Such advertiser and/or broadcaster value model may provide credit based on a number of criteria including, but, not limited to: the length of the advertisement, level of personalization, whether the advertisement is embedded in broadcasted content or separately viewed, the degree of viewer pull or push acquisition of the advertisement, the viewer's mood estimate relative to the relaxed mood, the verification of the actual viewing, etc.

To be sure a viewer actually watches an advertisement, a viewer feedback system can be implemented. Such feedback system may, e.g. consist of a message, in the form of a ticker line passing by at the bottom of the TV screen, asking the viewer to press a specific number on remote control 88, if he/she is watching the advertisement. To prevent abuse, the number to press optimally may change from advertisement to advertisement, in a random or other not easily predictable way. Also, the message may be optimally displayed towards the middle to end of an advertisement, rather than at its start, however not systematically to prevent abuse.

When credits on an advertisement account drop below a certain critical threshold level, the system supports the function to block the viewer or viewer group from fast forwarding commercials and/or automatically skipping commercials, for that broadcaster or group of broadcasters for whom the current advertisement account balance has reached a critical low level, until the viewer or viewer group earns sufficiently new credits to reach a critical switch-on level, e.g. by watching advertisement, or by transferring value, e.g., paying a sum of money, activating a coupon, etc.

The purchase or rent of VOD content or any other type of purchase which contributes to the advertiser or broadcaster value creation by means of commission on such purchase or otherwise, may also result in an increase of credits on an advertisement account associated with a viewer profile. In such a way broadcasters can earn a commission on VOD or other sales induced by special purpose advertisement, allowing for on-line TV ordering and in return grant credits on the viewer/purchaser's respective advertisement account.

In accordance with an illustrative embodiment, a user can “time shift” a commercial, i.e. he/she has the option to completely of partially skip the commercial while watching a video and view it later. Start and end position of commercial video blocks are detected in the video stream and are indicated in the chapter thumbnail bar 2002 associated as separate chapters highlighted in a different color, e.g. yellow, and an optional title added, e.g. letter “C” or “A”. In one embodiment, each user profile has an advertisement account associated therewith that keeps track of the time shifted commercials per channel. FIG. 21 illustrates conceptually a data structure 2100 useful for maintaining advertisement account associated with a user/viewer profile. As illustrated data structure 2100 comprises a viewer profile identifier data field 2102 identifying a viewer, an account type data field 2104 identifying the profile as being single or joint, and one or more channel identifier data fields 2106a-n Identifying various channels as described here in, and a current balance data field 2108a-n associated with each of the respective channel Identifier data fields. An initial balance in each of the current balance fields 2108a-n may be greater than zero, depending on the representation of value in the data type utilized within the field. Data structure 2100 may further comprise a navigation profile field 2110 which may be utilized to define one or more allowable or prohibited navigation activities, e.g. with a bit mask or code, or other data variable, for the identified user profile when the value in the current balance field 2108 is deficient. In one embodiment, each of channel identifier data fields 2106a-n has associated therewith a navigation profile field 2110 which may vary by channel. Note, in various embodiments, the data value stored in current balance field 2108 may represent value in any number of formats, including a time, currency format, points format, etc., depending on the implementation and the value assigned to each advertisement and its viewing or not viewing thereof. Data structure 2100 may further comprise a miscellaneous data field 2112 for storage of data per the system designer's discretion.

When the user time shifts a commercial, a certain amount is deducted from the current balance associated with that channel. e.g. the duration of the commercial in minutes/seconds. When the current balance associated with a channel is below a critical point, e.g. below zero, the user can no longer time shift a chapter in a program content object representing a commercial. When watching at least part of a time shifted commercial, an amount is added to the current balance associated with a channel, e.g. the duration of the viewed part of the commercial in minutes/seconds.

A user may watch the commercial block in order to avoid reduction of his/her advertisement account balance. If he/she has watched the chapter before the commercial block, e.g. watching is considered playing video for more than 30 seconds, the following rules may apply:

When a viewer is in a chapter that represents a commercial block:
fast forwarding is not allowed; rewind is allowed
slow fast forwarding is allowed and slow rewind as well
all other actions are allowed—if current balance for the channel is sufficient, but can lead to a decrease of the current balance, e.g. pressing next chapter
   When a viewer is in a chapter that is not a commercial block, but it is followed by a chapter that is a commercial block, and the user has watched that chapter, e.g. for more than 30 seconds, the following rules may apply:
the viewer can fast forward until the beginning of the next chapter which is a commercial block, then the video automatically starts to play, similar to fast forwarding and encountering the near live moment
all other actions are allowed—if current balance for the channel is sufficient but can lead to a decrease of the advertisement account balance, e.g. pressing next chapter twice to jump over the following commercial block

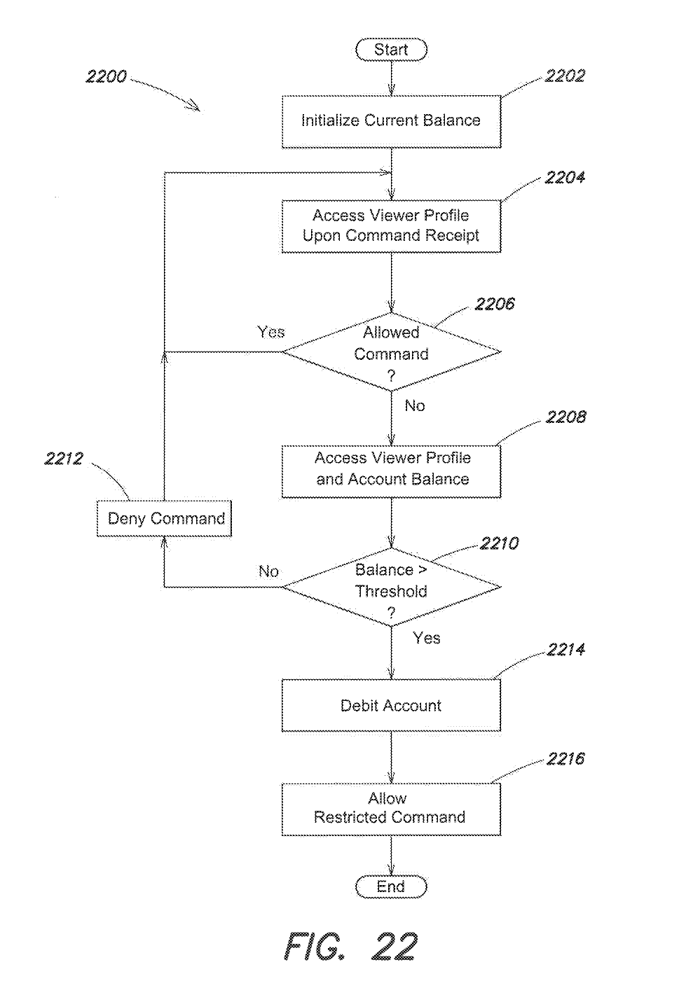

The flowchart of FIG. 22 illustrates the algorithmic process 2200 for modification of a viewer's advertisement account current balance relative to a viewer's advertisement viewing behavior. The algorithms necessary to perform such process may be combined into an executable code modules running on any of the interface system hardware described herein, either locally at the viewer's display system 32 or remotely over a server, such as those present in modeling system 35. To begin, at some point following startup of the executable code for the interface systems described herein, the current balance data field 2108 associated with each of the channels identified in channel identifier data fields 2106 are initialized, as illustrated by process block 2202. Note, such initialization does not have to occur simultaneously for all channels, but may occur at different times, e.g. when a new channel becomes available, etc. A command interpreter module associated with the interface systems described herein receives a viewer's requested navigational commands from remote control 88 or other user interface mechanism and accesses the data structure 2100 associated with the viewer's profile, as illustrated by procedure block 2204. Such navigational commands include an identifier of the requested activity. If the requested navigational command is one which is not subject to a restrictions, then the process returns to process block 2204 and awaits for other navigational commands, as illustrated by decisional block of the 2206. If the requested navigational command is one which may be subject to a restrictions relative to any advertising content within the currently viewed channel at the viewer's immediate position within the video stream, then the data structure 2100 associated with the viewer's profile is accessed to determine the value of the current balance fields 2108 associated with the identified channel, as illustrated by process block 2208. Note, the context of the command, e.g. the channel/program being viewed, the current position in the program, and identifier of any commercial or advertising content at the position subject to the navigational command, and the duration of the commercial chapter, may be accessed from the current state of the video playback engine associated with system 32 or may be transmitted as packet header information along with the navigation command. If the value of the current balance in data field 2108 is not within an acceptable range, e.g. at or below a predetermined threshold, and the requested navigation command is one subject to restriction if such threshold is not maintained, then requested navigation command will be denied, as illustrated by decisional block 2210 and process block 2212. Otherwise, if the appropriate value balance is present in the field 2108 associated with the particular channel, an appropriate amount of value is deducted from the value in data field 2108 and the requested navigation command is allowed to proceed, as illustrated by process blocks 2214 and 2216. Such process continues while the viewer Is viewing streamed content having commercial content or advertisements embedded there. In until a pause or exit command is given, as illustrated by decisional block 2218. Utilizing the described process, the time-shifting of advertisements and commercials may be achieved without advertisers losing value of their respective investments. Note that an amount of value in terms of currency, time, points, etc. may be added to the current balance field 2108 associated with a viewer profile in accordance with any of the techniques described herein.

Viewing Time Shifted Ads

When the viewer is watching commercial block “A” in a certain program, the following rules may apply:
the vertical navigation bar 1404B displays thumbnails of the commercial blocks that were previously time shifted; at the center is the current commercial block, below that the most recent commercial block, and so on until the oldest commercial block available
when navigating using directional commands from a remote, e.g. pressing arrow down key, to a commercial block, the commercial block starts to play from the start or from the position last viewed. When the selected commercial block ends:
   It is removed from the vertical navigation bar 1404B
   Video play resumes from the position in commercial block A where the user started to navigate in the vertical commercial dimension

Leaving the vertical commercial dimension can also be done:
By navigating back through the vertical dimension of vertical navigation bar 1404B using a directional key, e.g. the up arrow key of the remote control, to the commercial block A (last seen position) at the central position
Back-button on remote control 88 brings viewer back to last seen position in commercial block A

The logo of the vertical dimension may be the visualization of the current balance for one or more channels.

When watching a time shifted commercial, metadata shown on the main viewing area of the display, e.g., in the left upper corner may comprise the following elements:
Indication “COMMERCIAL” instead of the title of the program
time of broadcast, duration of the commercial, end time when watching from point last seen, product specifications, manufacturer information, contact information, etc.

### Visualization of Commercial Balance

The current balance of the advertisement account for a certain channel may be visualized as a gauge with the balance positioned at the central location of the vertical commercial dimension bar where normally the logo would appear.

The balance is visible:
Each time units are lost on the commercial account, the part lost may be represented in red or other color
Each time units are gained, the part gained may be displayed in green or other color

When a users' current balance is at or near a predefined critical minimum, the level may be shown in another color, e.g., orange.

There is no commercial account for a virtual channel, per se. Commercial time shifting functionalities for advertisement from other channels are tracked according to each program individually. When time shifting a commercial block in a program in a virtual channel the current balance of the corresponding natural channel is taken into account. As such, when accessing the vertical commercial navigation bar 1404B for watching time shifted commercials the time shifted commercials of the corresponding natural channel are taken into account.

### Personalized Advertisements

In accordance with another aspect of the disclosure, viewers have the option to view personalized commercials instead of viewing non-personalized commercials. Since the disclosed system and technique knows the viewing preferences based on the viewers' viewing and navigation behavior, the disclosed system and technique can, using the metadata describing the commercial ads, select and rank commercials according to the specific interest level and mood of the viewer, similar to the manner in which modeling system 35 ranks content objects. According to a viewer's emotional motivation to view the same. In this embodiment, personalized advertisements may be stored and separately linked to associated content.

In one embodiment, if a viewer pulls and views a personalized ad, he/she may obtain relatively more credits for the same viewing time compared to viewing non-personalized, commercials. For example, viewing a personalized ad of one minute could be equivalent of watching nonpersonal ads of five minutes. A parameter associated with each commercial advertisement may indicate whether the advertisement is non-personalized, or personalized, relative to the viewer profile, and may be provided with the other data describing the context in which the navigational command request is interpreted. Alternatively, all commercial advertisements may be identified as having greater value by associated with a particular channel or advertisement dimension.

Gaining Back Ad Shifting Credit

In one embodiment, a viewer has the possibility to regain credit by actually watching the time shifted commercials at a later moment in time. Instead of gaining back credits by viewing, a viewer can also pay, e.g. by means of a virtual wallet or associated account, to regain his/her commercial time shift credits.

Virtual Channel with Time-Shifted Commercials

In another embodiment of the disclosed system and technique, there is a virtual channel where all the times-shifted commercials or commercial blocks are aggregated. From the home position of such virtual commercial channel, the viewer can navigate through all commercials from all channels in the horizontal dimension using commands, such a the left right arrow keys of the remote control 88.

In the vertical dimension, using directional commands, e.g., the up and down arrow keys of the remote control 88, the viewer can select a specific broadcast channel. If he/she then starts navigating in the horizontal dimension, the viewer can navigate through the time shifted commercials of that broadcast channel.

Commercial Playlist in Each Broadcast Channel

In another embodiment of the disclosed system and technique, in each broadcast channel, there is the possibility to select in the vertical dimension of that channel, the advertisement playlist for that channel. If the viewer selects the commercial playlist for that channel using the channel navigation commands, e.g. the up or down remote arrow keys in a first dimension, he/she can then navigate in a second dimension through the commercials of that channel using the appropriate navigational arrow keys of the remote control 88.

Time Updating of Commercials

In another embodiment, the disclosed system and technique provides the possibility to update commercials in a time-shifted program based on the time aspect of a commercial, e.g., in a program that was aired one week ago and recorded by the viewer for later playback, there may be a commercial for the content or program that was aired two days after the original program was aired or for an event that took place three days after the original airing. If the viewer watches the commercial one week after the original program was aired, the commercial may be outdated. The disclosed system and technique provides the possibility to update stale commercials with commercials that are more recent and of greater value to the advertiser. Such technique may be implemented with the data structure comprising a date stamp and identifier associated with a particular advertisement and a link to the associated content program. If both new and older advertisements are stored and separately linked to associated content, a determination of the most current advertisement may be made by examining the identifier and timestamp associated with the content. If a newer advertisement is available, the link associated with the content may be updated to the newer advertisement. In this manner, the viewer will always be exposed to the advertiser's most recent advertisement, even if the program content is viewed in a time shifted manner. In another embodiment, the viewer may be prompted to view one or both advertisements and receive credit for viewing the second advertisement. Such an arrangement is advantageous where advertisements may be sequentially related arranged for viewing of the more recent advertisement makes less sense unless the first advertisement has been previously viewed.

Location Updating of Commercials

According to another embodiment, the disclosed system and technique provides the possibility to update or replace commercials based on the location aspect of such advertisement or commercial. Such system and technique may be implemented similarly as described above with the addition of a parameter associated with the advertisement which identifies geographic descriptor. Such technique may be particularly advantageous if content is being viewed in a time shifted manner on a mobile device which has a GPS or other geographic coordinate reference. Advertisements which are geographically relevant may be stored in a virtual channel and separately linked to associated content. In another embodiment, the viewer may be prompted to view one or both advertisements and receive credit for viewing the second advertisement.

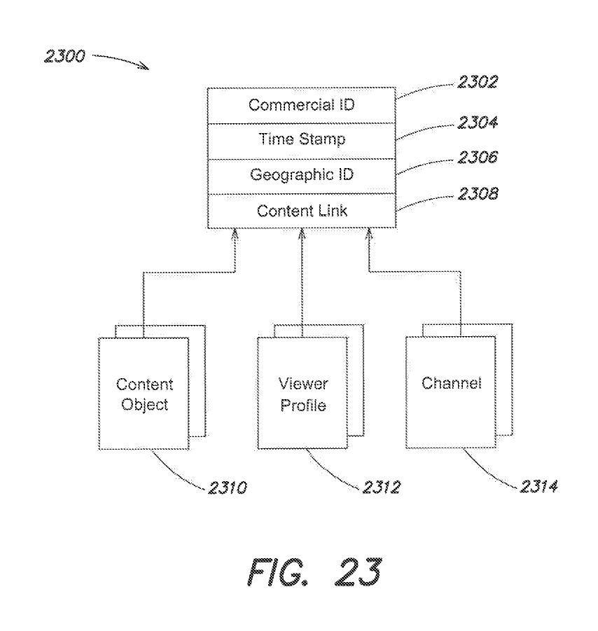

FIG. 23 illustrates a data structure, which may be associated with an advertisement to facilitate its preferential viewing, either as the most recent commercial or as the most geographically relevant personalized advertisement. As illustrated, a data structure 2300 comprises a commercial identification data field 2302, a timestamp data field 2304, the geographic identifier data field 2306, and a link field 2308 linking the commercial to its associated content. As illustrated in FIG. 23, data structure 2300 may be referenced by one or more of content objects 2310, specific viewer profiles 2312, or specific channels 2314, in order to facilitate the various techniques described herein.

Although the various embodiments of the system and techniques disclosed herein have been described with reference to content objects containing video data, the system described herein, particularly the tandem user interface and the neuropsychological modeling engine may be equally utilized with other types of content, including audio, art, advertisement, literature, physical objects, etc. with only minor modifications to the disclosed system and techniques as would be understood by those reasonably skilled in the relevant arts, given the disclosures as set forth herein.

It will be obvious to those reasonably skilled in the art that modifications to the systems and processes disclosed herein may occur, without departing from the true spirit and scope of the disclosure. For example, any two elements which communicate over a network or directly, may utilize either a push or a pull technique in addition to any specific communication protocol or technique described herein. Further, notwithstanding the network implementation described, any existing or future network or communications infrastructure technologies may be utilized, including any combination of public and private networks. In addition, although specific algorithmic flow diagrams or data structures may have been illustrated, these are for exemplary purposes only, other processes which achieve the same functions or utilized different data structures or formats are contemplated to be within the scope of the concepts described herein. Further, where specific data formats or colors are described, other data structures or colors may be similarly used with the same effect. As such, the exemplary embodiments described herein are for Illustrative purposes and are not meant to be limiting.

What is claimed is:

1. A system for viewing personalized advertisement content in a video stream comprising:
a video display;
a video playback engine responsive to viewer navigation commands for streaming video to the video display;
a memory for storing a viewer profile having associated therewith an account balance representing value to a viewer and references to a plurality of advertisement content sections recommended in accordance with the viewer profile;
a processor operatively coupled with the memory and video playback engine and configured to:
i) stream with the video playback engine a video content object comprising video content and one or more advertisement content sections,
ii) receive, from the viewer, a command instruction to view an advertisement content section other than an advertisement section in the content object, and
iii) stream with the video playback engine at least one of the plurality of advertisement content sections recommended in accordance with the viewer profile.

2. The system of claim 1 wherein the value of the account balance associated with the viewer profile represents a time quantity and wherein the processor is further configured to:
iv) credit the value of the account balance by an amount equal to viewing time duration of the advertisement content section recommended in accordance with the viewer profile.

3. The system of claim 1 wherein at least one of the advertisement content sections recommended in accordance with the viewer profile is chronologically newer than the advertisement content section in the content object.

4. The system of claim 1 wherein at least one of the advertisement content sections recommended in accordance with the viewer profile is geographically more relevant to the viewer than the advertisement content section in the content object.

5. A method for viewing personalized advertisement content in a video stream comprising:
A) maintaining, in a computer memory, a viewer profile having associated therewith an account balance representing value to a viewer and references to a plurality of advertisement content sections recommended in accordance with the viewer profile;
B) presenting a video stream of a video content object comprising video content and one or more advertisement content sections,
C) receiving, from the viewer, a command instruction to view an advertisement content section other than one of the advertisement content sections in the content object, and
D) presenting, in place of the advertisement content section in the content object, at least one of the plurality of advertisement content sections recommended in accordance with the viewer profile.

6. The method of claim 5 wherein the value of the account balance associated with the viewer profile represents a time quantity and wherein the method further comprises:
E) crediting the value of the account balance by an amount equal to viewing time duration of the advertisement content section recommended in accordance with the viewer profile.

7. The method of claim 6 wherein E) comprises:
E1) crediting the value of the account balance by an amount equal to viewing time duration of the advertisement content section multiplied by a scaling factor of greater than one.

8. The method of claim 5 wherein at least one of the advertisement content sections recommended in accordance with the viewer profile is chronologically newer than the one advertisement content section in the content object.

9. The method of claim 5 wherein at least one of the advertisement content sections recommended in accordance with the viewer profile is geographically more relevant to the viewer than the one advertisement content section in the content object.
